(19) United States
(12) Patent Application Publication
(10) Pub. No.: US 2012/0164745 A1
(43) Pub. Date: Jun. 28, 2012

(54) NANOFINGER DEVICE WITH MAGNETIZABLE PORTION

(76) Inventors: Kai-Mei Camilla Fu, Palo Alto, CA (US); Jianhua Yang, Palo Alto, CA (US); Fung Suong Ou, Palo Alto, CA (US)

(21) Appl. No.: 12/978,989

(22) Filed: Dec. 27, 2010

(51) Int. Cl. G01N 21/75; B82Y 15/00

(52) U.S. Cl. 436/164; 422/82.05; 977/957

(57) ABSTRACT

A nanofinger device with magnetizable portion. The nanofinger device includes a substrate, and a plurality of nanofingers coupled with the substrate. A nanofinger of the plurality includes a flexible column, and at least one magnetizable portion. At least the nanofinger and a second nanofinger of the plurality of nanofingers are to arrange into a close-packed configuration. The magnetizable portion is to actuate the nanofinger in opening from the close-packed configuration in response to a physical stimulus affecting the magnetic state of the magnetizable portion. A chemical-analysis apparatus including the nanofinger device for chemical sensing and a method of using the nanofinger device for chemical sensing are also provided.

### RELATED APPLICATIONS

This application is related to PCT Patent Application, Serial Number PCT/US10/31790 by Zhiyong Li, et al., filed on Apr. 20, 2010, entitled “MULTI-PILLAR STRUCTURE FOR MOLECULAR ANALYSIS,” and assigned to the assignee of the present invention. This application is also related to PCT Patent Application, Serial Number PCT/US10/31809 by Zhiyong Li, et al., filed on Apr. 20, 2010, entitled “A SELF-ARRANGING, LUMINESCENCE-ENHANCEMENT DEVICE FOR SURFACE-ENHANCED LUMINESCENCE,” and assigned to the assignee of the present invention.

### TECHNICAL FIELD

Examples of the present invention relate generally to nanofinger devices.

### BACKGROUND

Chemical-sensing techniques that employ surface-enhanced luminescence, such as surface-enhanced Raman spectroscopy (SERS), have emerged as leading-edge techniques for the analysis of the structure of complex organic molecules, in particular, biomolecules and even biological cells, viruses and their macromolecular components. For example, in SERS, scientists engaged in the application of Raman spectroscopy have found that it is possible to enhance the intensity of a Raman spectrum of a molecule. By decorating a surface, upon which a molecule is later adsorbed, with a thin layer of a noble metal, surface plasmons are generated that have frequencies in the range of electromagnetic radiation emitted by such a molecule that enhance the intensity of the Raman spectrum of the molecule.

Moreover, spectroscopists utilizing spectroscopic techniques for the analysis of molecular structures have a continuing interest in improving the efficiency of their spectroscopic techniques. Laboratory through-put is one of the primary metrics of a well-functioning chemical laboratory. Moreover, the cost of laboratory equipment, glassware, and consumables can make the utilization of a high sensitivity analytical technique prohibitively expensive. For example, the increased sensitivity associated with SERS analysis comes at the price of substrates coated with expensive precious metals such as gold. Thus, scientists engaged in the application of surface-enhanced luminescence techniques are motivated to increase the efficiency and cost-effectiveness of surface-enhanced luminescence techniques, such as, SERS.

### DESCRIPTION OF THE DRAWINGS

The accompanying drawings, which are incorporated in and form a part of this specification, illustrate examples of the invention and, together with the description, serve to explain the examples of the invention:

FIG. 1A is a perspective view of a nanofinger device with magnetizable portion, in accordance with one or more examples of the present invention.

FIG. 1B is a cross-sectional elevation view, along a portion of line 2-2 of FIG. 1A, of a first example nanofinger device with one or more magnetizable portions, which may include superparamagnetic particles, in accordance with one or more examples of the present invention.

FIG. 1C is a cross-sectional elevation view, along a portion of line 2-2 of FIG. 1A, of a portion of a second example nanofinger device with one or more magnetizable portions that are ferromagnetic, in accordance with one or more examples of the present invention.

FIG. 1D is a cross-sectional elevation view, along a portion of line 2-2 of FIG. 1A, of a portion of a third example nanofinger device with one or more magnetizable portions that are thermomagnetic, in accordance with one or more examples of the present invention.

FIG. 1E is a cross-sectional elevation view, along a portion of line 2-2 of FIG. 1A, of a fourth example nanofinger device with magnetizable portion that is a magnetic cap coated with a surface-enhanced Raman spectroscopy (SERS) active metal for chemical sensing, in accordance with one or more examples of the present invention.

FIG. 2 is a cross-sectional elevation view, through line 2-2 of FIG. 1A, of the nanofinger device for chemical sensing with magnetizable portion in contact with a fluid, for example, a liquid, carrying a plurality of molecules, in accordance with one or more examples of the present invention.

FIG. 3 is a cross-sectional elevation view, through line 2-2 of FIG. 1A, of the nanofinger device for chemical sensing with magnetizable portion that shows nanofingers self-arranging into close-packed configurations with molecules disposed between metallic caps of nanofingers, in accordance with one or more examples of the present invention.

FIG. 4 is another perspective view of the nanofinger device for chemical sensing with magnetizable portion of FIG. 1A after the nanofingers have self-arranged into close-packed configurations with molecules disposed between the metallic caps, in accordance with one or more examples of the present invention.

FIGS. 5A, 5B and 5C are cross-sectional elevation views at various stages in the fabrication of the nanofinger device for chemical sensing with magnetizable portion of FIG. 1A illustrating a sequence of processing operations used in fabrication, in accordance with one or more examples of the present invention.

FIG. 6 is a perspective view of the nanofinger device for chemical sensing with magnetizable portion disposed in a microfluidic channel, in accordance with one or more examples of the present invention.

FIG. 7 is a perspective view of a chemical-analysis apparatus including the nanofinger device for chemical sensing with magnetizable portion, in accordance with one or more examples of the present invention.

FIG. 8 is a flowchart of a method of using the nanofinger device for chemical sensing with magnetizable portion, in accordance with one or more examples of the present invention.

The drawings referred to in this description should not be understood as being drawn to scale except if specifically noted.

### DESCRIPTION OF EXAMPLES

Reference will now be made in detail to the alternative examples of the present invention. While the invention will be described in conjunction with the alternative examples, it will be understood that they are not intended to limit the invention to these examples. On the contrary, the invention is intended to cover alternatives, modifications and equivalents, which may be included within the spirit and scope of the invention as defined by the appended claims.

Furthermore, in the following description of examples of the present invention, numerous specific details are set forth in order to provide a thorough understanding of the present invention. However, it should be noted that examples of the present invention may be practiced without these specific details. In other instances, well known methods, procedures, and components have not been described in detail as not to unnecessarily obscure examples of the present invention. Throughout the drawings, like components are denoted by like reference numerals, and repetitive descriptions are omitted for clarity of explanation if not necessary.

Examples of the present invention include a nanofinger device with magnetizable portion. The nanofinger device includes a substrate, and a plurality of nanofingers coupled with the substrate. A nanofinger of the plurality includes a flexible column, and at least one magnetizable portion. At least the nanofinger and a second nanofinger of the plurality of nanofingers are to arrange into a close-packed configuration. The magnetizable portion is to actuate the nanofinger in opening from the close-packed configuration in response to a physical stimulus affecting the magnetic state of the magnetizable portion. Examples of the present invention also include a chemical-analysis apparatus including the nanofinger device for chemical sensing with magnetizable portion and a method of using the nanofinger device for chemical sensing with magnetizable portion.

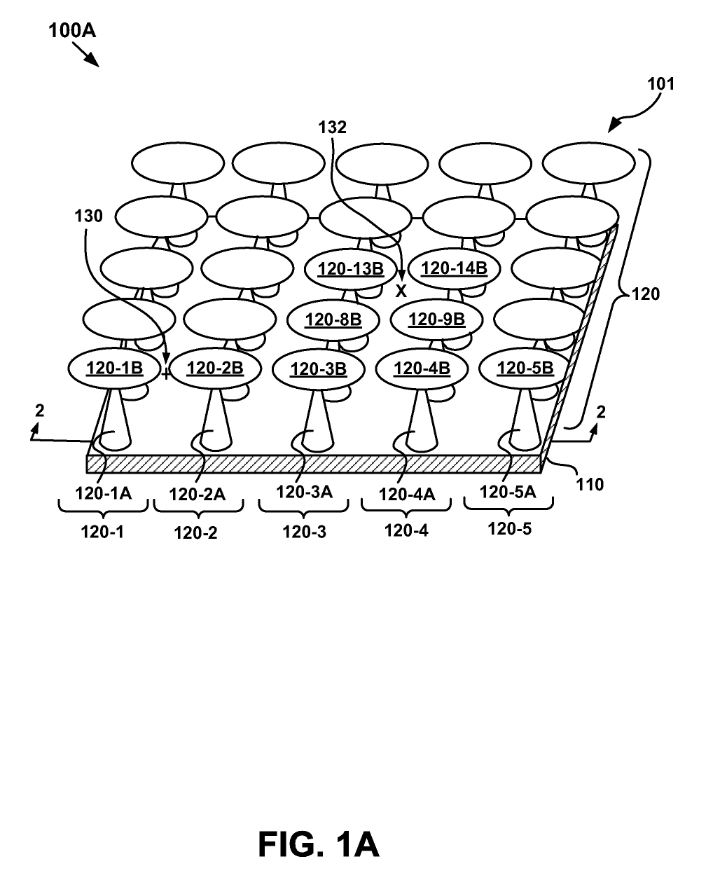

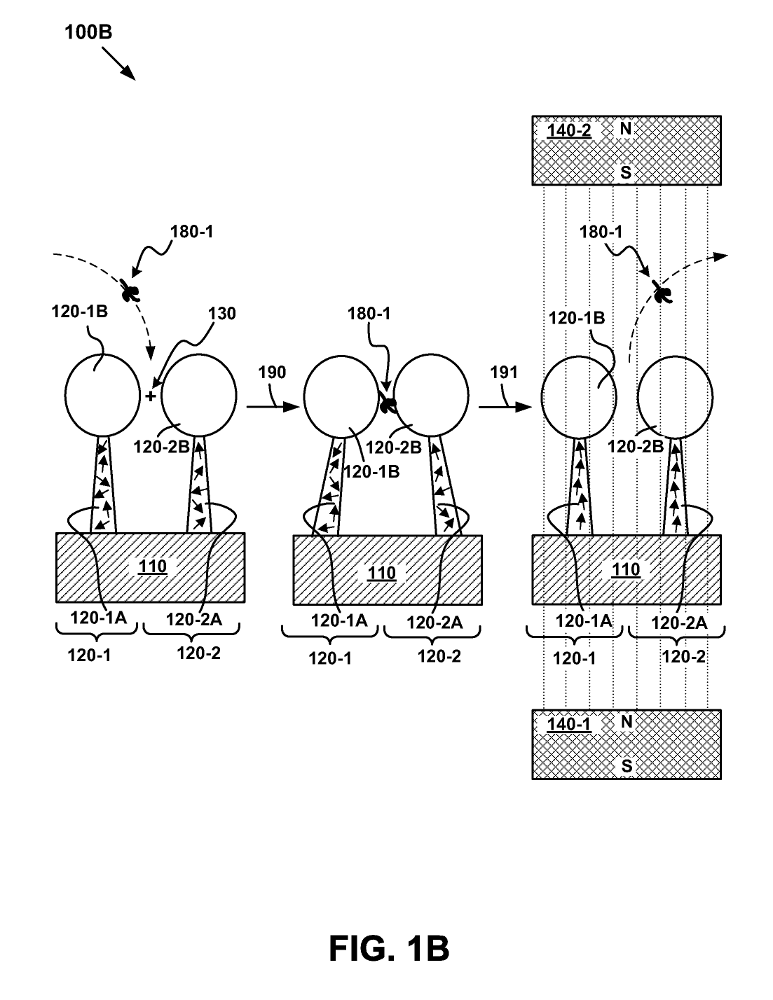

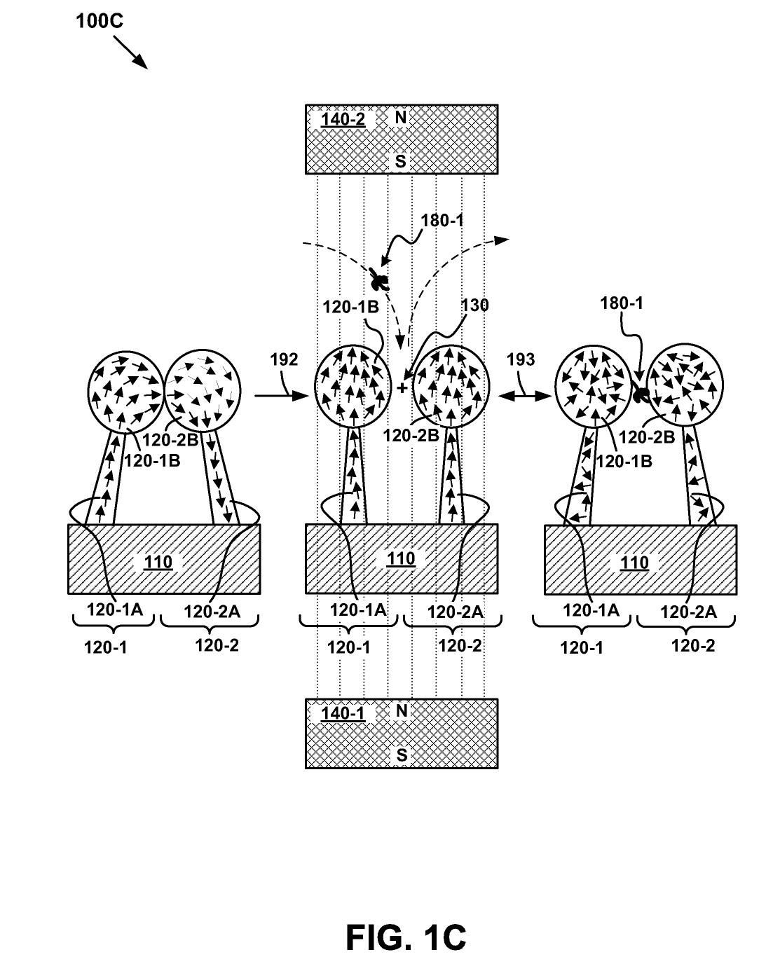

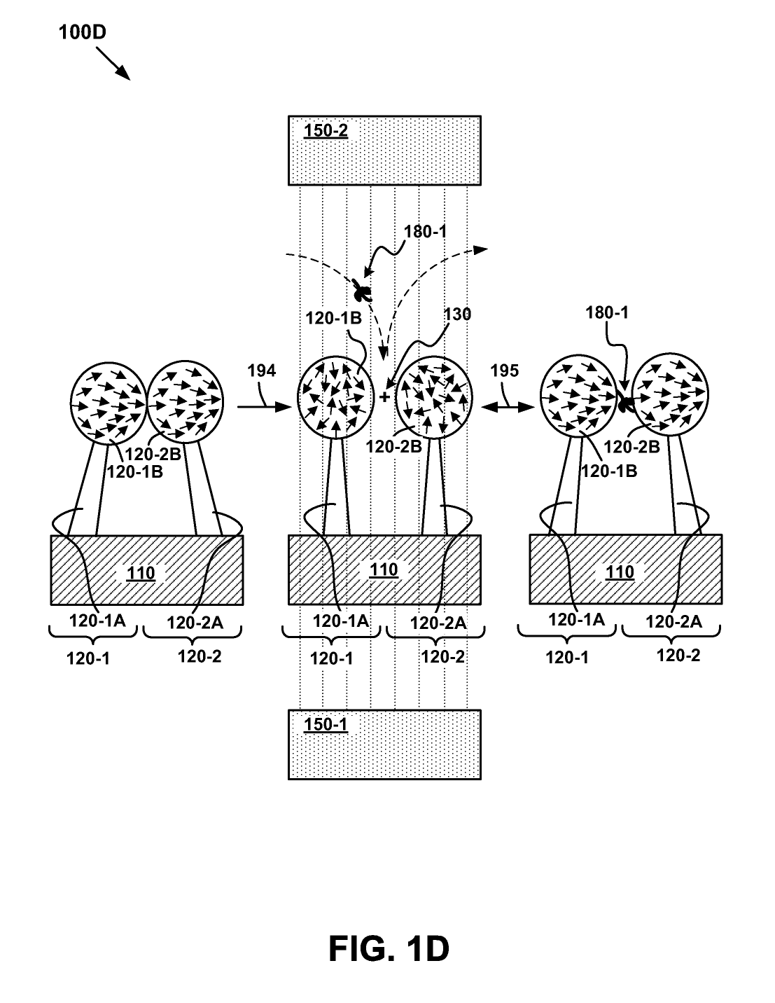

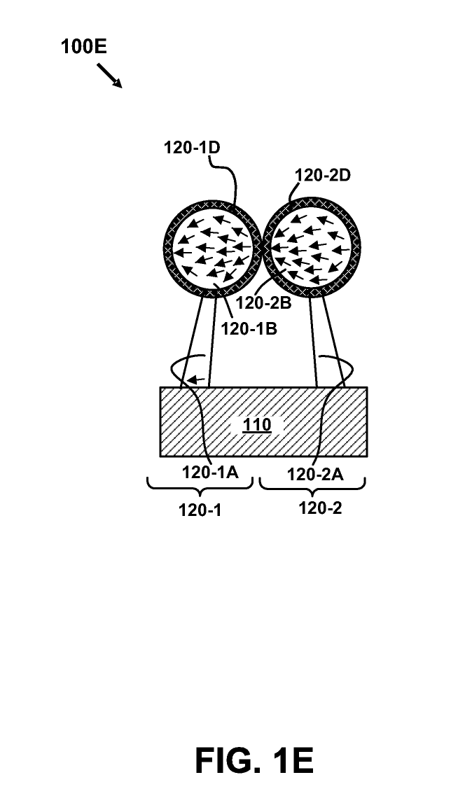

With reference now to FIG. 1A, in accordance with one or more examples of the present invention, a perspective view 100A is shown of the nanofinger device 101 with magnetizable portions. By way of examples of the present invention, the nanofinger device 101 with magnetizable portions may provide for surface-enhanced Raman spectroscopy (SERS) for the chemical analysis of one or more analyte molecules, without limitation thereto, as is subsequently described in greater detail. But, other examples of the present invention include a nanofinger device 101 with magnetizable portions that may provide for surface-enhanced luminescence, more generally, for applications other than chemical analysis. The nanofinger device 101 with magnetizable portions includes the substrate 110, and the plurality 120 of nanofingers, for example, nanofingers 120-1, 120-2, 120-3, 120-4 and 120-5. The nanofinger 120-1 of the plurality 120 includes the flexible column 120-1A, and a metallic cap 120-1B, which may be composed all, or in part, of a SERS-active metal. Similarly, other nanofingers, for example, nanofingers 120-2, 120-3, 120-4 and 120-5, of the plurality 120 include flexible columns, for example, flexible columns 120-2A, 120-3A, 120-4A and 120-5A, respectively, and metallic caps, for example, metallic caps 120-2B, 120-3B, 120-4B and 120-5B, respectively. One or more portions of the plurality 120 of nanofingers, by way of example, a metallic cap and/or a flexible column, without limitation thereto, may be magnetizable so that the nanofingers may be magnetically actuated. As shown in FIG. 1A, by way of example, a row of nanofingers includes nanofingers 120-1, 120-2, 120-3, 120-4 and 120-5, without limitation thereto. Also, by way of example, an array of nanofingers includes several rows, without limitation thereto. Thus, in accordance with one example of the present invention, the plurality 120 of nanofingers includes the array of nanofingers including several rows of nanofingers. However, other arrangements of nanofingers that are less well-ordered than shown in FIG. 1A are also within the spirit and scope of examples of the present invention. The arrangement shown in FIG. 1A is illustrative of but one example of an arrangement of the plurality 120 of nanofingers in a nanofinger device 101 with magnetizable portions as may be fabricated in a top-down fabrication procedure, which employs a reticulated mask in a photolithographic process. However, other methods of fabrication are also within the spirit and scope of examples of the present invention, which are subsequently described. Moreover, the morphology of the metallic caps may differ from that shown in FIG. 1A. For example, the morphology of the metallic caps may be substantially spherical, or alternatively, truncated substantially spherical, for example, with a morphology similar to that of the head of a match stick, and the metallic caps themselves may be coated with a SERS-active coating, in accordance with one or more examples of the present invention, which are also subsequently described.

With further reference to FIG. 1A, in accordance with one or more examples of the present invention, a top portion including a metallic cap of a nanofinger, for example, nanofinger 120-1, of the plurality 120 of nanofingers may have the shape of an ellipsoid. However, in accordance with one or more examples of the present invention, a top portion including a metallic cap of a nanofinger is not limited to having the shape of an ellipsoid, as other shapes, in particular spheres as subsequently described, are also within the spirit and scope of examples of the present invention.

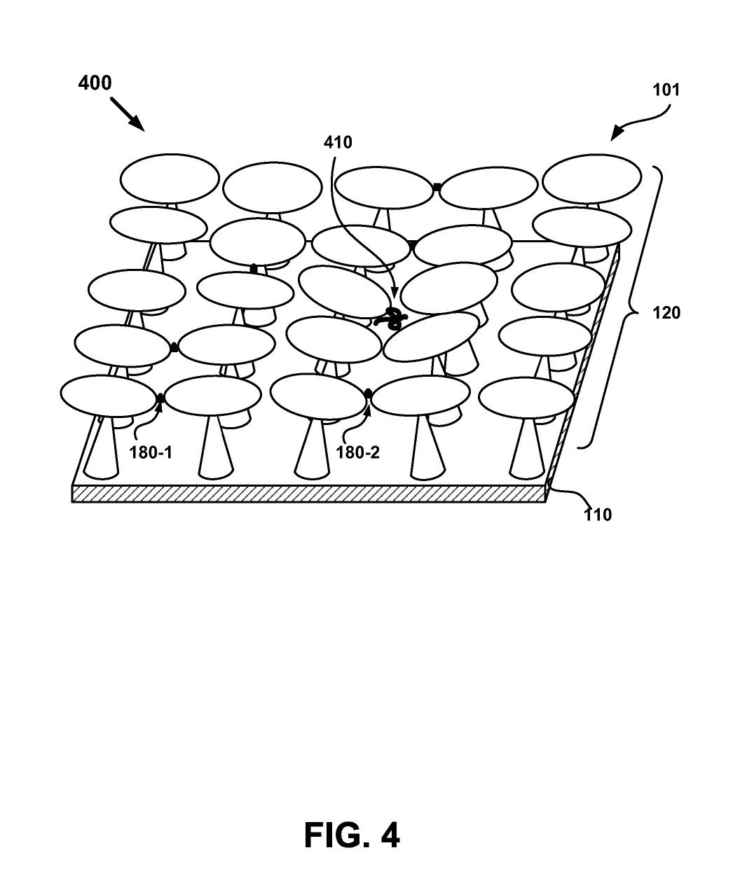

With further reference to FIG. 1A, by way of example, in accordance with one or more examples of the present invention, the flexible columns may have the form of nanocones, as shown in FIGS. 1A and 4, without limitation thereto. However, more generally, the flexible columns may be selected from the group consisting of: nanocones, nanopyramids, nanorods, nanobars, nanopoles and nanograss, without limitation thereto. As used herein, the terms of art, “nanocones,” “nanopyramids,” “nanorods,” “nanobars,” “nanopoles” and “nanograss,” refer to structures that are substantially: conical, pyramidal, rod-like, bar-like, pole-like and grass-like, respectively, which have nano-dimensions as small as a few tens of nanometers (nm) in height and a few nanometers in diameter, or width. For example, flexible columns may include nano-columns having the following dimensions: a diameter of 10 nm to 500 nm, a height of 20 nm to 2 micrometers (μm), and a gap between flexible columns of 20 nm to 500 nm. The terms of art, “substantially conical,” “substantially pyramidal,” “substantially rod-like,” “substantially bar-like,” “substantially pole-like” and “substantially grass-like,” means that the structures have nearly the respective shapes of cones, pyramids, rods, bars, poles and grass-like asperities within the limits of fabrication with nanotechnology.

With further reference to FIG. 1A, by way of example, without limitation thereto, in accordance with one or more examples of the present invention, the metallic caps may have the form of oblate nanoellipsoids, as shown in FIGS. 1A and 4. However, more generally, the metallic caps may be selected from the group consisting of: nanospheres, prolate nanoellipsoids, oblate nanoellipsoids, nanodisks, and nanoplates, without limitation thereto. In particular, a magnetic portion of the nanofinger device including a metallic cap having the form of a prolate nanoellipsoid may possess shape-induced magnetic anisotropy. As used herein, the terms of art, “nanospheres,” “prolate nanoellipsoids,” “oblate nanoellipsoids,” “nanodisks,” and “nanoplates,” refer to structures that are substantially: spherical, prolate ellipsoidal, oblate ellipsoidal, disk-like, and plate-like, respectively, which have nano-dimensions as small as a few nanometers in size: height, diameter, or width. For example, in accordance with one or more examples of the present invention, the diameter of the metallic caps is on the order of 10 nm to 500 nm. In addition, the terms of art, “substantially spherical,” “substantially prolate ellipsoidal,” “substantially oblate ellipsoidal,” “substantially disk-like,” and “substantially and plate-like,” means that the structures have nearly the respective shapes of spheres, prolate ellipsoids, oblate ellipsoids, disks, and plates within the limits of fabrication with nanotechnology.

Also, as used herein, the term of art, “molecule,” may be used to refer to the smallest unit of an element consisting of one or more like atoms, the smallest unit of a compound consisting of one or more like or different atoms, and more generally to any very small particle, for example, a biological cell, a virus, or molecular component of a biological cell or a virus. Also, as used herein the term of art, “target,” also includes an analyte molecule selected from the group consisting of molecules, organic molecules, biomolecules, biological cells, viruses and the molecular components of biological cells and viruses.

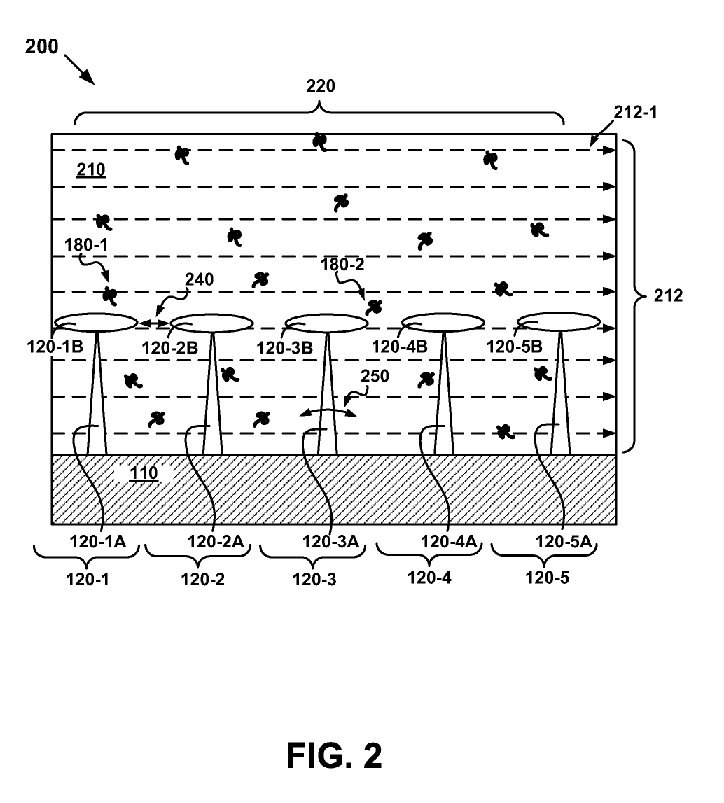

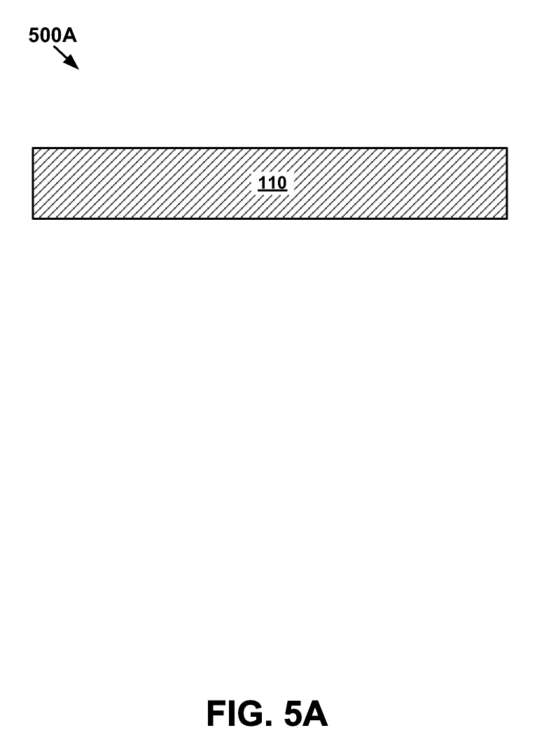

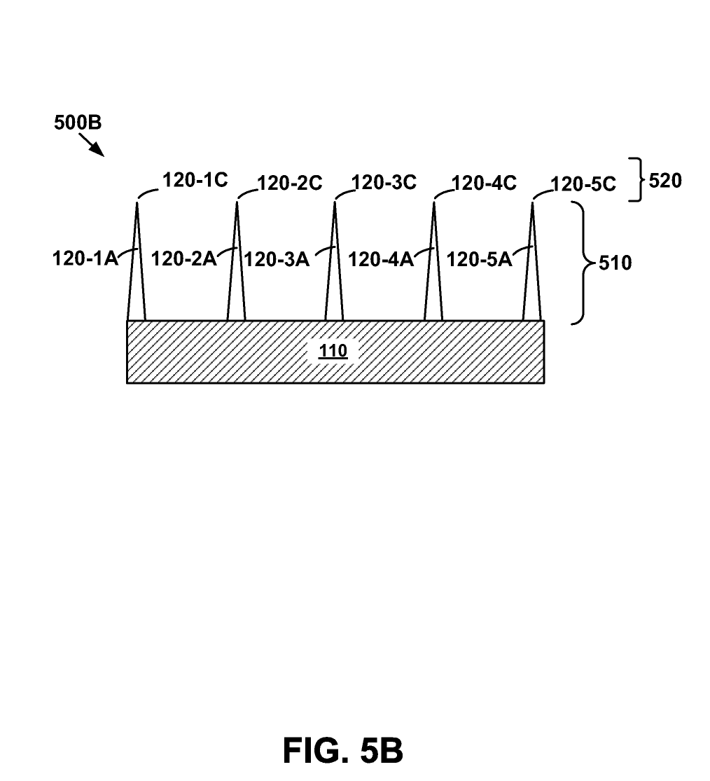

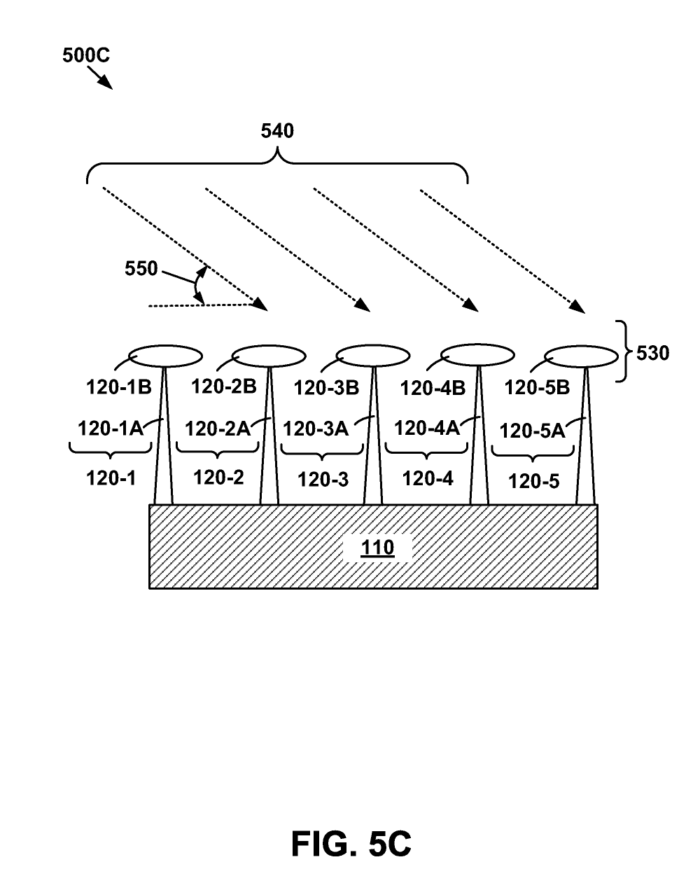

With further reference to FIG. 1A, in accordance with one or more examples of the present invention, the metallic cap 120-1B is coupled to an apex 120-1C (not shown in FIG. 1A, but see FIGS. 5B and 5C) of the flexible column 120-1A. Similarly, other metallic caps, for example, metallic caps 120-2B, 120-3B, 120-4B and 120-5B, are coupled to apices, for example, apices 120-2C, 120-3C, 120-4C and 120-5C, respectively, (not shown in FIG. 1A, but see FIGS. 5B and 5C) of flexible columns, for example, flexible columns 120-2A, 120-3A, 120-4A and 120-5A, respectively. As shown in FIG. 1A, a plurality of interstices is disposed between the plurality 120 of nanofingers, which is relevant to examples of the present invention directed to chemical analysis, as by SERS. For example, a small interstice 130 is located between metallic cap 120-1B and metallic cap 120-2B. By way of further example, an interstice of a different kind, a large interstice 132, is located between four metallic caps 120-8B, 120-9B, 120-13B and 120-14B. Such interstices are to receive analyte molecules (not shown, but see FIG. 2) for the purpose of surface-enhanced luminescence. As used herein, the term of art, “surface-enhanced luminescence,” also embraces within the scope of its meaning surface-enhanced Raman emission, as in surface-enhanced Raman spectroscopy (SERS), surface-enhanced reflectivity, surface-enhanced light scattering, and surface-enhanced fluorescence. In accordance with one or more examples of the present invention, at least the nanofinger 120-1 and a second nanofinger 120-2 of the plurality 120 are to self-arrange into a close-packed configuration with at least one analyte molecule 180-1 (not shown, but see FIG. 2) disposed between at least the metallic cap 120-1B and a second metallic cap 120-2B of respective nanofinger 120-1 and second nanofinger 120-2, for example, at the location of the small interstice 130, as is next described with the aid of a cross-section through line 2-2.

With reference now to FIG. 1B, in accordance with one or more examples of the present invention, a cross-sectional elevation view 100B is shown of a portion of a first example of the nanofinger device 101 depicting various arrangements of the plurality 120 of nanofingers. FIG. 1B shows the sequence of events, separated by arrows 190 and 191, associated with actuating magnetizable portions of the nanofinger device 101. In the discussions herein of the nanofinger device 101, reference is made to an analyte molecule 180-1, by way of example without limitation thereto, as examples of the present invention also include within their spirit and scope environments in which magnetizable portions of the nanofinger device 101 may be actuated in the absence of an analyte molecule. In accordance with one or more examples of the present invention, the nanofinger device 101 with magnetizable portions includes a substrate 110, and a plurality 120 of nanofingers coupled with the substrate 110. A nanofinger 120-1 of the plurality 120 includes a flexible column 120-1A, and at least one magnetizable portion. For example, the flexible column 120-1A may include a composite structure formed from a dispersion of a plurality of magnetizable particles in a non-magnetic matrix. A magnetizable particle may be selected from the group consisting of a superparamagnetic particle, a paramagnetic particle, a magnetic particle, and any combination of foregoing members of the group. As shown in FIG. 1B, the magnetization vectors of the individual magnetizable portions, which may include magnetizable particles, in the flexible columns 120-1A and 120-2A are indicated by the arrows.

With further reference to FIG. 1B, as shown to the left of arrow 190, in accordance with one or more examples of the present invention, nanofingers 120-1 and 120-2 are shown in their initially unmagnetized state, as indicated by the random orientation of the arrows corresponding to the magnetization vectors of individual magnetizable portions, which may include magnetizable particles, in the flexible columns 120-1A and 120-2A. By way of example, as shown in FIG. 1B, the random orientation of the arrows corresponding to the magnetization vectors in the flexible columns 120-1A and 120-2A may be associated with one or more magnetizable portions, which may include superparamagnetic particles, without limitation thereto. As shown in FIG. 1B, the nanofingers 120-1 and 120-2 are disposed nominally perpendicular to the substrate 110 such that the interstice 130 is exposed for capturing an analyte molecule, for example, analyte molecule 180-1, between the tip portions of the nanofingers 120-1 and 120-2. As shown in FIG. 1B, by way of example without limitation thereto, the tip portions of the nanofingers 120-1 and 120-2 may include metallic caps 120-1B and 120-2B, respectively. However, examples of the present invention also include within their spirit and scope tip portions without metallic caps. Also, by way of example, the metallic caps 120-1B and 120-2B are shown in FIG. 1B as having a nominally spherical morphology. However, as previously described, examples of the present invention are not limited to metallic caps 120-1B and 120-2B having a nominally spherical morphology.

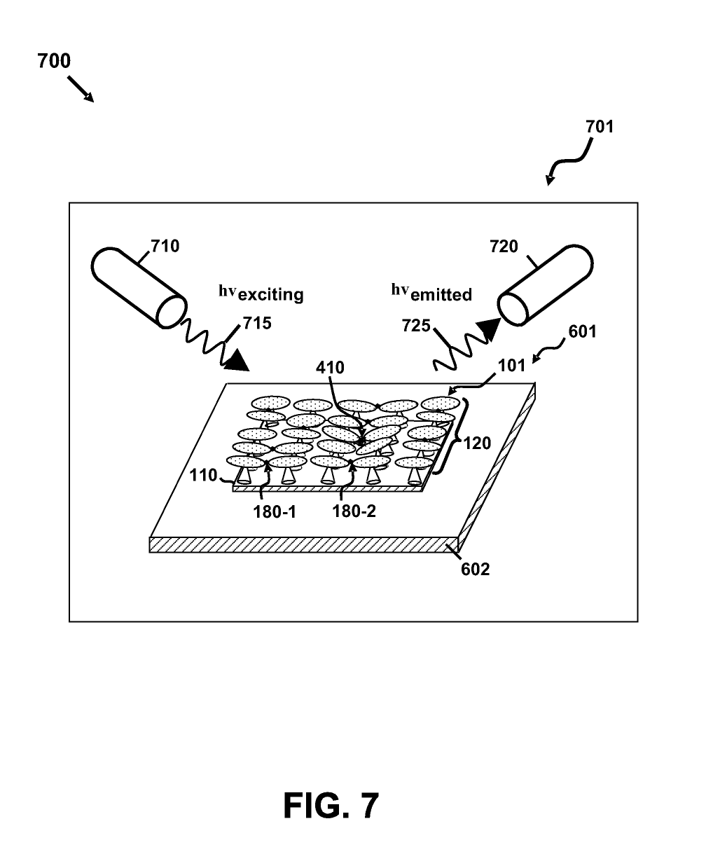

With further reference to FIG. 1B, if, as shown to the immediate right of arrow 190, the analyte molecule 180-1 finds its way to the interstice 130, the nanofingers 120-1 and 120-2 of the plurality 120 of nanofingers may arrange into a close packed configuration. In one or more examples of the present invention, the nanofinger 120-1 and the second nanofinger 120-2 of the plurality 120 of nanofingers upon arranging into the close-packed configuration and upon illumination with exciting electromagnetic radiation 715 (see FIG. 7) may produce an enhanced optical response greater than an optical response in the absence of arranging into the close-packed configuration. In one or more examples of the present invention, the nanofinger device 101 may further include a chemical sensor for at least one analyte molecule 180-1. The nanofinger 120-1 and the second nanofinger 120-2 of the plurality 120 of nanofingers are to arrange into the close-packed configuration with the analyte molecule 180-1 disposed in between respective tip portions of the nanofinger 120-1 and the second nanofinger 120-2. Also, the nanofinger 120-1 and the second nanofinger 120-2 of the plurality 120 of nanofingers are to produce an enhanced optical response associated with the analyte molecule 180-1 greater than an optical response in the absence of arranging into the close-packed configuration with the analyte molecule 180-1. The enhanced optical response associated with the analyte molecule 180-1 may include surface-enhanced Raman luminescence.

By way of example, one mechanism by which the nanofingers 120-1 and 120-2 of the plurality 120 of nanofingers may arrange into close packed configurations is by microcapillary forces exerted on the flexible columns 120-1A and 120-2A, which is subsequently described in greater detail in the discussion of FIG. 2, without limitation thereto. However, examples of the present invention also include within their spirit and scope other mechanisms by which the nanofingers 120-1 and 120-2 of the plurality 120 of nanofingers may arrange into close packed configurations. For example, in accordance with one or more examples of the present invention, at least one magnetizable portion of a nanofinger, for example, nanofinger 120-1, may actuate the nanofinger in closing into a close-packed configuration with a neighboring nanofinger, for example, nanofinger 120-2, in response to a physical stimulus affecting a magnetic state of the magnetizable portion. Similarly, in accordance with one or more examples of the present invention, at least one magnetizable portion of a nanofinger, for example, nanofinger 120-1, may actuate the nanofinger in opening from a close-packed configuration with a neighboring nanofinger, for example, nanofinger 120-2, in response to a physical stimulus affecting a magnetic state of the magnetizable portion, as is next described.

With further reference to FIG. 1B, as shown to the right of arrow 191, in accordance with one or more examples of the present invention, the nanofinger device 101 may further include at least one magnet, for example, one of magnets 140-1 and 140-2. The magnet is to apply an applied magnetic field, indicated in FIG. 1B by the dotted lines between magnets 140-1 and 140-2, to magnetizable portions, for example, the magnetizable particles in flexible columns 120-1A and 120-2A, of the plurality 120 of nanofingers to alter a configuration of the plurality 120 of nanofingers. For example, in opening the nanofingers 120-1 and 120-2, the magnetizable portion is to actuate the nanofinger 120-1 in opening from the close-packed configuration in response to a physical stimulus, by way of example, the applied magnetic field, indicated in FIG. 1B by the dotted lines between magnets 140-1 and 140-2, affecting the magnetic state of the magnetizable portion. As shown in FIG. 1B, the applied magnetic field extends from the north pole of magnet 140-1 to the south pole of magnet 140-2. Consequently, the magnetization vectors associated with the individual magnetizable particles in a flexible columns 120-1A and 120-2A become aligned along the field lines of the applied magnetic field. To minimize energy in the applied magnetic field, individual magnetizable particles, which may compose the magnetizable portions of the flexible columns 120-1A and 120-2A, straighten out the flexible columns 120-1A and 120-2A so that the flexible columns may become aligned nominally perpendicular to the substrate 110 and open up the interstice 130. As a result, the analyte molecule 180-1 is released from the interstice 130 located between the tip portions of nanofingers 120-1 and 120-2. In accordance with one or more examples of the present invention, to provide for cyclic, or repeated, operation of the nanofinger device 101, physical stimuli used to open an interstice, for example, interstice 130, may be used in conjunction with physical stimuli used to close the interstice.

With reference now to FIG. 1C, in accordance with one or more examples of the present invention, a cross-sectional elevation view 100C, along a portion of line 2-2 of FIG. 1A, is shown of a portion of a second example of the nanofinger device 101. The second example of the nanofinger device 101 of FIG. 1C includes one or more magnetizable portions that are ferromagnetic, by way of example, ferromagnetic particles in the flexible columns 120-1A and 120-2A and/or magnetic domains in ferromagnetic metallic caps 120-1B and 120-2B, without limitation thereto. FIG. 1C shows the sequence of events, separated by single-headed arrow 192 and double-headed arrow 193, associated with actuating magnetizable portions of the nanofinger device 101. As shown to the left of single-headed arrow 192, in accordance with one or more examples of the present invention, nanofingers 120-1 and 120-2 are shown in an initially magnetized state, as indicated by the head-to-tail orientation of the arrows corresponding to the magnetization vectors of individual magnetizable portions of the nanofingers 120-1 and 120-2. By way of example, as shown in FIG. 1C, the head-to-tail orientation of the arrows corresponding to the magnetization vectors of individual magnetizable portions in the nanofingers 120-1 and 120-2 may be associated with one or more magnetizable portions including ferromagnetic portions such as ferromagnetic particles in flexible columns 120-1A and 120-2A and/or magnetic domains in ferromagnetic metallic caps 120-1B and 120-2B, without limitation thereto. As shown in FIG. 1C, to the left of single-headed arrow 192, the nanofingers 120-1 and 120-2 are disposed nominally at inclined angles to the substrate 110 such that the interstice 130 is closed and precluded from capturing an analyte molecule, for example, analyte molecule 180-1, between the tip portions of the nanofingers 120-1 and 120-2. As shown in FIG. 1C, by way of example without limitation thereto, the tip portions of the nanofingers 120-1 and 120-2 may include the metallic caps 120-1B and 120-2B, respectively, which are magnetized. However, examples of the present invention also include within their spirit and scope tip portions without metallic caps.

With further reference to FIG. 1C, as shown to the right of single-headed arrow 192, in accordance with one or more examples of the present invention, the nanofinger device 101 may further include at least one magnet, for example, one of magnets 140-1 and 140-2. One or both of the magnets 140-1 and 140-2 may include permanent magnets, electromagnets, and virtual magnets, the latter of which are produced by image fields of a real magnet in a yoke and/or pole tip made of a susceptible magnetic material situated opposite to one of the magnets 140-1 and 140-2 at the location of magnet 140-2 and 140-1, respectively. The magnet, for example, magnet 140-1 and/or magnet 140-2, is to apply an applied magnetic field, indicated in FIG. 1C by the dotted lines between magnets 140-1 and 140-2, to magnetizable portions, for example, the magnetizable particles in flexible columns 120-1A and 120-2A and magnetizable metallic caps 120-1B and 120-2B, of nanofingers 120-1 and 120-2. Thus, the applied magnetic field may alter a configuration of the plurality 120 of nanofingers. For example, in opening the nanofingers 120-1 and 120-2, the magnetizable portion is to actuate the nanofinger 120-1 in opening from the close-packed configuration in response to a physical stimulus, by way of example, the applied magnetic field, indicated in FIG. 1C by the dotted lines between magnets 140-1 and 140-2, affecting the magnetic state of the magnetizable portion. As shown in FIG. 1C, the applied magnetic field extends from the north pole of magnet 140-1 to the south pole of magnet 140-2. Consequently, the magnetization vectors associated with the metallic caps 120-1B and 120-2B and the individual magnetizable particles in a flexible columns 120-1A and 120-2A become aligned along the field lines of the applied magnetic field. To minimize energy in the applied magnetic field, the individual magnetizable particles, which compose the magnetizable portions of the flexible columns 120-1A and 120-2A, straighten out the flexible columns 120-1A and 120-2A so that the flexible columns 120-1A and 120-2A may become aligned nominally perpendicular to the substrate 110 and open up the interstice 130. As a result, the analyte molecule 180-1 may be captured at the interstice 130 located between the tip portions of nanofingers 120-1 and 120-2.

With further reference to FIG. 1C, if, as shown to the immediate right of double-headed arrow 193, the analyte molecule 180-1 finds its way to the interstice 130, the nanofingers 120-1 and 120-2 of the plurality 120 of nanofingers may arrange into a close packed configuration. For example, the magnetizable portions of the nanofingers 120-1 and 120-2 may be degaussed by cycling through magnetization loops of ever decreasing amplitude. Upon completion of the degaussing operation, nanofingers 120-1 and 120-2 are in a demagnetized state, as indicated by the random orientation of the arrows corresponding to the magnetization vectors of individual magnetizable portions of the nanofingers 120-1 and 120-2. Alternatively, if the magnetizable portions are superparamagnetic nanoparticles, the applied magnetic field may be reduced below the critical magnetic field of the superparamagnetic nanoparticles, without degaussing. Then, one mechanism by which the nanofingers 120-1 and 120-2 of the plurality 120 of nanofingers may arrange into close packed configurations is by microcapillary forces exerted on the flexible columns 120-1A and 120-2A, which is subsequently described in greater detail in the discussion of FIG. 2, without limitation thereto. Alternatively, in one or more examples of the present invention, the magnetizable portion is to actuate the nanofingers in closing into the close-packed configuration in response to a physical stimulus affecting the magnetic state of the magnetizable portion. For example, the magnetizable portions of the nanofingers 120-1 and 120-2 may be left in a remanent magnetic state such that a magnetic moment remains on the magnetizable portions of each of the nanofingers 120-1 and 120-2. To minimize the magnetic energy associated with the magnetizable portions of nanofingers 120-1 and 120-2 having magnetizations associated with the magnetic moments aligned in the same direction, the magnetic domains of the magnetizable portions within the nanofingers 120-1 and 120-2 may rearrange themselves such that the tips of the nanofingers 120-1 and 120-2 close the interstice 130 that lies between the tips of the nanofingers 120-1 and 120-2. Subsequently, an applied magnetic field may be reapplied to the nanofinger device 101 as shown to the left of double-headed arrow 193, but now, to open up the interstice 130 and release the analyte molecule 180-1.

With reference now to FIG. 1D, in accordance with one or more examples of the present invention, a cross-sectional elevation view 100D, along a portion of line 2-2 of FIG. 1A, is shown of a portion of a third example of nanofinger device 101. The nanofinger device 101 of FIG. 1D includes one or more magnetizable portions that are thermomagnetic, by way of example, thermomagnetic metallic caps 120-1B and 120-2B, without limitation thereto. Thus, in accordance with one or more examples of the present invention, the physical stimulus applied to the nanofinger device 101 may be selected from the group consisting of a change in temperature and a change in applied magnetic field. As used herein, the term of art, “thermomagnetic,” refers to the property by which a magnetic material changes its ferromagnetic susceptibility to magnetization with a change in temperature. For example, as the temperature of the magnetic material increases above the Curie temperature, the magnetic material loses its ferromagnetic susceptibility to magnetization. Furthermore, as the temperature of the magnetic material decreases below the Curie temperature the magnetic material once again regains its ferromagnetic susceptibility to magnetization. Thus, ferromagnetic materials, ferrimagnetic materials, and superparamagnetic materials, without limitation thereto, exhibited thermomagnetic properties and may also be referred to, herein, as thermomagnetic.

With further reference to FIG. 1D, in accordance with one or more examples of the present invention, the sequence of events, which are separated by single-headed arrow 194 and double-headed arrow 195, is shown that are associated with actuating magnetizable portions of the nanofinger device 101. As shown to the left of single-headed arrow 194, in accordance with one or more examples of the present invention, the metallic caps 120-1B and 120-2B of respective nanofingers 120-1 and 120-2 are shown in an initially magnetized state, as indicated by the head-to-tail orientation of the arrows corresponding to the magnetization vectors of individual magnetizable portions of the nanofingers 120-1 and 120-2, for example, metallic caps 120-1B and 120-2B. By way of example, as shown in FIG. 1D, the head-to-tail orientation of the arrows corresponding to the magnetization vectors of individual magnetizable portions in the nanofingers 120-1 and 120-2 may be associated with one or more magnetizable portions including thermomagnetic portions, such as ferromagnetic metallic caps 120-1B and 120-2B, without limitation thereto. As shown in FIG. 1D, the nanofingers 120-1 and 120-2 are disposed nominally at inclined angles to the substrate 110 such that the interstice 130 is closed and precluded from capturing an analyte molecule, for example, analyte molecule 180-1, between the tip portions of the nanofingers 120-1 and 120-2. As shown in FIG. 1D, by way of example without limitation thereto, the tip portions of the nanofingers 120-1 and 120-2 may include the metallic caps 120-1B and 120-2B, respectively, which are magnetized. However, examples of the present invention also include within their spirit and scope tip portions without metallic caps.

With further reference to FIG. 1D, as shown to the right of single-headed arrow 194, in accordance with one or more examples of the present invention, the nanofinger device 101 may further include at least one thermal reservoir, for example, one of thermal reservoirs 150-1 and 150-2. One or both of the thermal reservoirs 150-1 and 150-2 may include a heater and/or a cooler. The thermal reservoir, for example, thermal reservoir 150-1 and/or thermal reservoir 150-2, is to change a temperature, which is associated with a corresponding heat flow indicated in FIG. 1D by the dotted lines between thermal reservoirs 150-1 and 150-2, of magnetizable portions, for example, the magnetizable metallic caps 120-1B and 120-2B, of nanofingers 120-1 and 120-2. Thus, the change in temperature may alter a configuration of the plurality 120 of nanofingers. For example, in opening the nanofingers 120-1 and 120-2, the magnetizable portion is to actuate the nanofinger 120-1 in opening from the close-packed configuration in response to a physical stimulus, by way of example, the change in temperature, which is associated with the corresponding heat flow indicated in FIG. 1D by the dotted lines between thermal reservoirs 150-1 and 150-2, affecting the magnetic state of the magnetizable portion. Consequently, the magnetization vectors associated with the metallic caps 120-1B and 120-2B become randomized when the temperature exceeds the Curie temperature of the magnetizable portions of the nanofingers 120-1 and 120-2 so that elastic restoring forces in the flexible columns 120-1A and 120-2A orient the nanofingers 120-1 and 120-2 about perpendicular to the substrate 110. To minimize elastic energy of the flexible columns 120-1A and 120-2A, the flexible columns 120-1A and 120-2A straighten out, when the individual magnetizable portions, by way of example, the ferromagnetic metallic caps 120-1B and 120-2B, lose their magnetic moment above the Curie temperature. Thus, columns may become oriented nominally perpendicular to the substrate 110 and open up the interstice 130. As a result, the analyte molecule 180-1 may be captured at the interstice 130 located between the tip portions of nanofingers 120-1 and 120-2.

With further reference to FIG. 1D, if, as shown to the immediate right of double-headed arrow 195, the analyte molecule 180-1 finds its way to the interstice 130, the nanofingers 120-1 and 120-2 of the plurality 120 of nanofingers may arrange into a close packed configuration. For example, with elevation of the temperature of the magnetizable portions of the nanofingers 120-1 and 120-2 above the Curie temperature of the magnetizable portions, the magnetizable portions of the nanofingers 120-1 and 120-2 become demagnetized. The demagnetized state is indicated by the random orientation of the arrows corresponding to the magnetization vectors of individual magnetizable portions, for example, the magnetic domains in the metallic caps 120-1B and 120-2B, of the nanofingers 120-1 and 120-2. Then, one mechanism by which the nanofingers 120-1 and 120-2 of the plurality 120 of nanofingers may arrange into close packed configurations is by microcapillary forces exerted on the flexible columns 120-1A and 120-2A, which is subsequently described in greater detail in the discussion of FIG. 2, without limitation thereto. Alternatively, in one or more examples of the present invention, the magnetizable portion is to actuate the nanofingers in closing into the close-packed configuration in response to a physical stimulus affecting the magnetic state of the magnetizable portion. For example, as the temperature of the magnetizable portions of the nanofingers 120-1 and 120-2 is lowered below the Curie temperature, the magnetizable portions of the nanofingers 120-1 and 120-2 may spontaneously remagnetize and regain a magnetic moment on each of the metallic caps 120-1B and 120-2B of nanofingers 120-1 and 120-2. To minimize the magnetic energy associated with nanofingers 120-1 and 120-2 having magnetizations associated with the magnetic moments, the magnetic domains within the nanofingers 120-1 and 120-2 may rearrange themselves such that the tips of the nanofingers 120-1 and 120-2 close the interstice 130 that lies between the tips of the nanofingers 120-1 and 120-2. Subsequently, heat may be applied to elevate the temperature of the magnetizable portions of the nanofingers 120-1 and 120-2 of the nanofinger device 101 above the Curie temperature as shown to the left of double-headed arrow 195, but now, to open up the interstice 130 and release the analyte molecule 180-1.

With reference now to FIG. 1E, in accordance with one or more examples of the present invention, a cross-sectional elevation view 100E, along a portion of line 2-2 of FIG. 1A, is shown of a fourth example of nanofinger device 101. The nanofinger device 101 of FIG. 1E includes a magnetizable portion that is a magnetic cap coated with a SERS-active metal for chemical sensing. By way of example, as shown in FIG. 1E, the nanofinger device 101 includes a plurality 120 of nanofingers, for example, nanofingers 120-1 in 120-2, disposed on substrate 110. Nanofinger 120-1 includes a flexible column 120-1A, the metallic cap 120-1B, and SERS-active metallic coating 120-1D disposed on the metallic cap 120-1B. Similarly, nanofinger 120-2 includes a flexible column 120-2A, the metallic cap 120-2B, and SERS-active metallic coating 120-2D disposed on the metallic cap 120-2B. By way of example, the metallic caps may be composed of a magnetic material, without limitation thereto, as described above. Alternatively, other portions of the nanofingers of the plurality 120 of nanofingers may be coated with magnetic material to produce a magnetic coating. For example, nonmagnetic flexible columns may be coated with magnetic material, by means subsequently described in the discussion of FIG. 5C. The magnetic materials selected for providing magnetizable portions coating various component parts of the nanofingers, as well as the magnetic materials used for magnetizable portions of the nanofingers themselves, are next described.

With further reference to FIGS. 1A-1E, in accordance with one or more examples of the present invention, magnetizable portions of the nanofinger device 101 may include a structure selected from the group consisting of a superparamagnetic particle, a paramagnetic particle, a magnetic particle, a ferromagnetic coating of the flexible column, a ferromagnetic flexible column, a ferromagnetic cap disposed at an apex of the flexible column, a thermomagnetic coating of the flexible column, a thermomagnetic flexible column, and a thermomagnetic cap disposed at an apex of the flexible column, and any combination of foregoing members of the group. Moreover, in one or more examples of the present invention, the superparamagnetic particle may include a material selected from the group consisting of magnetite, maghemite, cobalt, iron, nickel, magnetic alloys of cobalt, magnetic alloys of iron, and magnetic alloys of nickel. In other examples of the present invention, the ferromagnetic coating may include a material selected from the group consisting of cobalt, iron, nickel, magnetic alloys of cobalt, magnetic alloys of iron, and magnetic alloys of nickel. Similarly, in one or more examples of the present invention, the ferromagnetic cap may also include a material selected from the group consisting of cobalt, iron, nickel, magnetic alloys of cobalt, magnetic alloys of iron, and magnetic alloys of nickel. In yet other examples of the present invention, the thermomagnetic coating may include a material selected from the group consisting of gadolinium, manganese arsenide, and a ferromagnetic material having a Curie temperature between greater than about 0° C. and less than about 100° C. Similarly, in one or more examples of the present invention, the thermomagnetic cap may also include a material selected from the group consisting of gadolinium, manganese arsenide, and a ferromagnetic material having a Curie temperature between greater than about 0° C. and less than about 100° C. Thermomagnetic materials having a Curie temperature between greater than about 0° C. and less than about 100° C. allow for the use of the nanofinger device 101 for biological applications in which a fluid, such as water, is in the liquid state. Depending on the type of materials used in the magnetizable portions of the structures of the nanofinger device 101, various physical stimuli for actuating the nanofinger device may be employed, by way of example, applying an applied magnetic field to saturate the magnetizable portions, applying an applied magnetic field to degauss the magnetizable portions, removing an applied magnetic field, elevating the temperature of the magnetizable portions above the Curie temperature, lowering the temperature of the magnetizable portions below the Curie temperature, and combinations of these, without limitation thereto. However, as described above, the closure of the nanofingers of the nanofinger device 101 may also be affected by microcapillary forces, which are next described.

With reference now to FIG. 2, in accordance with one or more examples of the present invention, a cross-sectional elevation view 200 through line 2-2 of FIG. 1A is shown of the nanofinger device 101 with magnetizable portions, as utilized for chemical sensing. FIG. 2 shows a row of nanofingers 120-1, 120-2, 120-3, 120-4 and 120-5 in profile. Nanofingers 120-1, 120-2, 120-3, 120-4 and 120-5 include flexible columns 120-1A, 120-2A, 120-3A, 120-4A and 120-5A, and metallic caps 120-1B, 120-2B, 120-3B, 120-4B and 120-5B, respectively. As shown in FIG. 2, the range of flexibility of each of the flexible columns 120-1A, 120-2A, 120-3A, 120-4A and 120-5A is indicated by the example double headed arrow 250, which is shown overlaying flexible column 120-3A. As further shown in FIG. 2, the row of nanofingers 120-1, 120-2, 120-3, 120-4 and 120-5 of the nanofinger device 101 is to come into contact with a fluid 212 including a fluid carrier 210, for example, a liquid or a gas, carrying a plurality 220 of analyte molecules, for example, analyte molecules 180-1 and 180-2. By way of example, as shown in FIG. 2, the fluid may be in motion, without limitation thereto, as indicated by flow vectors, of which flow vector 212-1 is an example. Such a configuration might be suitable for sampling an environment with the nanofinger device 101 for the presence of a target molecule, also referred to herein as a “target,” without limitation thereto.

Alternatively, the fluid, for example, a liquid, may be static without motion, as might be the case for immersion of the nanofinger device 101 in a solution containing an analyte including the liquid and molecules, also more generally analyte molecules, of which the analyte is composed. Thus, the nanofinger device 101 is to receive molecules, also more generally analyte molecules, of an analyte for spectroscopic analysis as is SERS, surface-enhanced fluorescence spectroscopy, surface-enhanced reflectivity, surface-enhanced light scattering, or other surface-enhanced luminescence applications.

With further reference to FIG. 2, in accordance with one or more examples of the present invention, an analyte molecule 180-1 may approach the site of an interstice, for example, small interstice 130, where adjacent metallic caps, for example, metallic caps 120-1B and 120-2B, are separated by a distance 240. In accordance with an example of the present invention, a metallic cap, for example, metallic cap 120-1B, of the plurality 120 of nanofingers is to bind to a analyte molecule 180-1 disposed in close proximity to the metallic cap 120-1B. By way of example, such binding may occur through Van der Waals forces between the metallic cap 120-1B and the analyte molecule 180-1, without limitation thereto. Alternatively, such binding may occur through other types of binding forces, such as surface physisorption or surface chemisorption of the molecule by the metallic cap 120-1B, without limitation thereto. Once the molecule is bound to the metallic cap, for example, metallic cap 120-1B, in accordance with an example of the present invention, at least one metallic cap, for example, metallic cap 120-1B, of a plurality 530 (see FIG. 5C) of metallic caps is to enhance luminescence from the analyte molecule 180-1 disposed in close proximity to the metallic cap 120-1B. Moreover, in accordance with another example of the present invention, at least one metallic cap, for example, metallic cap 120-1B, of the plurality 530 (see FIG. 5C) of metallic caps may be composed of a constituent that enhances surface luminescence, such as a material selected from the group consisting of copper, silver, aluminum and gold, or any combination of copper, silver, aluminum and gold. Furthermore, in accordance with another example of the present invention, the flexible columns 120-1A, 120-2A, 120-3A, 120-4A and 120-5A of the plurality 120 of nanofingers 120-1, 120-2, 120-3, 120-4 and 120-5 further include a flexible material selected from the group, which includes both dielectric and non-dielectric materials, consisting of a highly cross-linked uv-curable or thermal-curable polymer, a highly cross-linked uv-curable or thermal-curable plastic, a polysiloxane compound (for example, polyphenylmethyl siloxane (PPMS)), an epoxy-based negative photoresist (for example, SU-8), silicon, silicon dioxide, spin-on glass, a sol-gel material, silicon nitride, diamond, diamond-like carbon, aluminum oxide, sapphire, zinc oxide, and titanium dioxide, without limitation thereto, the purpose of which is next described.

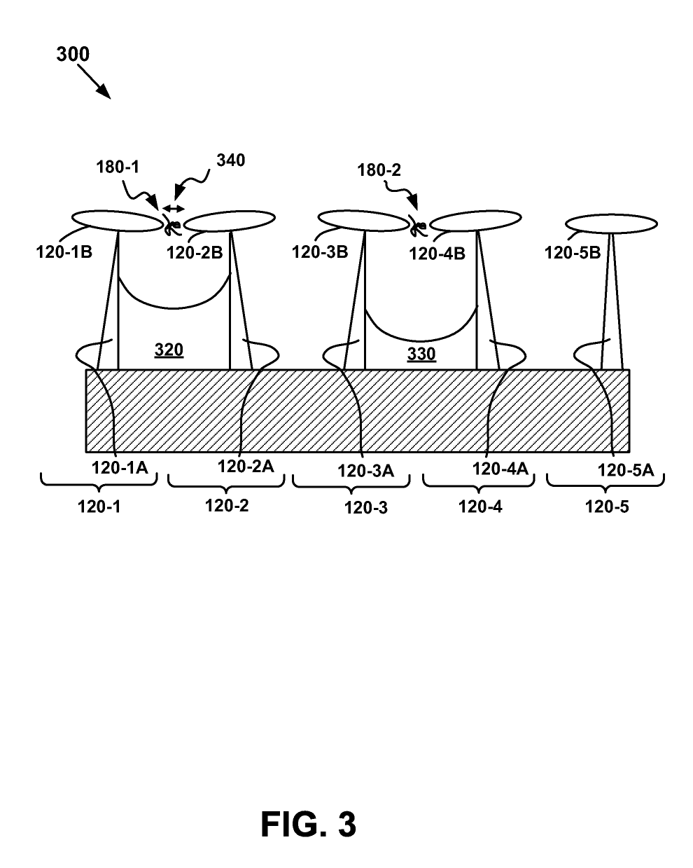

With reference now to FIG. 3, in accordance with one or more examples of the present invention, a cross-sectional elevation view 300 through line 2-2 of FIG. 1A is shown of the nanofinger device 101 with magnetizable portions, as utilized for chemical sensing. FIG. 3 shows nanofingers 120-1, 120-2, 120-3 and 120-4 self-arranging into close-packed configurations with analyte molecules, for example, analyte molecule 180-1, disposed between metallic caps 120-1B and 120-2B of the nanofingers 120-1 and 120-2, respectively, and analyte molecule 180-2, disposed between metallic caps 120-3B and 120-4B of the nanofingers 120-3 and 120-4, respectively. Because the flexible columns 120-1A, 120-2A, 120-3A and 120-4A of the plurality 120 of nanofingers include a flexible, or compliant, material as described above, in accordance with an example of the present invention, at least one flexible column 120-1A is to bend towards at least a second flexible column 120-2A, and to dispose the analyte molecule 180-1 in close proximity with at least a second metallic cap 120-2B on the second flexible column 120-2A. If the fluid is a liquid, liquid pools 320 and 330, may remain trapped between the flexible columns, for example, flexible columns 120-1A and 120-2A, and flexible columns 120-3A and 120-4A, respectively, which give rise to microcapillary forces exerted upon the flexible columns. The microcapillary forces serve to draw together the flexible columns, for example, flexible columns 120-1A and 120-2A, and flexible columns 120-3A and 120-4A, as the liquid evaporates, which allows the nanofingers 120-1 and 120-2 to self-arrange into a close-packed configuration with at least one analyte molecule 180-1 disposed between at least the metallic cap 120-1B and a second metallic cap 120-2B of respective nanofinger 120-1 and second nanofinger 120-2.

Thus, with further reference to FIG. 3, in accordance with one or more examples of the present invention, the flexible column 120-1A is to bend towards the second flexible column 120-2A under action of microcapillary forces induced by removal of the fluid carrier 210 provided to carry the analyte molecule 180-1 into proximity with the metallic cap 120-1B and second metallic cap 120-2B. In accordance with another example of the present invention, a spacing 340 of the close-packed configuration between the metallic cap 120-1B and second metallic cap 120-2B with a analyte molecule 180-1 disposed between the metallic cap 120-1B and second metallic cap 120-2B is determined by a balance of binding forces, between the analyte molecule 180-1 and the metallic cap 120-1B and second metallic cap 120-2B, with restoring forces exerted by the flexible column 120-1A and second flexible column 120-2A due to displacement of the flexible column 120-1A and second flexible column 120-2A towards the analyte molecule 180-1. If magnetic moments are present in magnetizable portions of the nanofingers, magnetic forces between magnetizable portions of a nanofinger, for example, ferromagnetic metallic caps, may also play a role in this balance of forces. Thus, in accordance with an example of the present invention, the spacing 340 approaches a limit determined by the size of the analyte molecule 180-1, which may be as small as 0.5 nm. The spacing 340 approaches the physical limit of the smallest possible separation between metallic caps 120-1B and 120-2B. Thus, the metallic caps act as two antennas approaching the largest coupling that may be possible between at least two such antennas for surface-enhanced luminescence. Moreover, the effect of coupling more than two metallic caps acting as antennas is also within the spirit and scope examples of the present invention, which is next described.

With reference now to FIG. 4 and further reference to FIGS. 1A-1E and 3, in accordance with one or more examples of the present invention, another perspective view 400 is shown of the nanofinger device 101 with magnetizable portions of FIGS. 1A-1E, as utilized for chemical sensing. As shown in FIG. 4, most of the nanofingers of the plurality 120 have self-arranged into close-packed configurations with analyte molecules, for example, analyte molecules 180-1, 180-2 and 410, disposed between the metallic caps, for example, metallic caps 120-1B and 120-2B, metallic caps 120-3B and 120-4B, and metallic caps 120-8B, 120-9B, 120-13B and 120-14B, respectively. In accordance with one or more examples of the present invention, the corresponding flexible columns coupled with the metallic caps have bent towards adjacent flexible columns, as might occur under action of microcapillary forces induced by removal of the fluid carrier 210, as for removal of a liquid. For example, the small interstices, similar to small interstice 130, are to capture smaller analyte molecules, for example, analyte molecules 180-1 and 180-2. On the other hand, the large interstices, similar to large interstice 132, are to capture larger analyte molecules, for example, analyte molecule 410. In accordance with one or more examples of the present invention, the size of the analyte molecules captured is determined by the self-arranging spacing between the metallic caps, for example, the spacing 340 of the close-packed configuration between the metallic cap 120-1B and second metallic cap 120-2B with the analyte molecule 180-1 disposed between the metallic cap 120-1B and second metallic cap 120-2B. By way of example, the size of the self-arranging spacing may be on the order of 2 nm, without limitation thereto. Thus, in accordance with one or more examples of the present invention, the nanofinger device 101 may provide a device for the capture of analyte molecules of various sizes from a solution carrying an analyte of at least one particular molecular species. For example, the nanofinger device 101 may then be used in SERS analysis of the captured molecules of an analyte, which is subsequently described in greater detail.

With reference now to FIGS. 5A, 5B and 5C, in accordance with yet other examples of the present invention, cross-sectional elevation views 500A, 500B and 500C, respectively, are shown of the nanofinger device 101 with magnetizable portions of FIGS. 1A-1E, at various stages of fabrication of the nanofinger device 101. FIGS. 5A, 5B and 5C illustrate a sequence of processing operations used in fabrication of the nanofinger device 101. FIG. 5A shows the substrate 110 upon which the rest of the structure of the nanofinger device 101 is fabricated. In accordance with one or more examples of the present invention, the substrate may be a material selected from the group consisting of silicon, glass, quartz, silicon nitride, sapphire, aluminum oxide, diamond, diamond-like carbon, one or more plastics, and one or more metals and metallic alloys, without limitation thereto. In accordance with one or more examples of the present invention, the substrate may be in a form selected from the group consisting of a sheet, a wafer, a film and a web. For example, if the substrate is in the form of a web, the substrate may be used as feed stock, as rolls of material in a roll-to-roll fabrication process. For another example, the substrate may be in the form of a flexible polymer film composed of a plastic material, such as polyimide, polyethylene, polypropylene, or some other suitable polymeric plastic. Thus, in accordance with one or more examples of the present invention, the substrate may be either rigid, as for a semiconductor wafer, or flexible, as for the web.

With further reference now to FIGS. 5B and 1A-1E, in accordance with one or more examples of the present invention, a cross-sectional elevation view 500B is shown of the nanofinger device 101 with magnetizable portions of FIGS. 1A-1E, at an intermediate stage of fabrication. FIG. 5B shows a plurality 510 of flexible columns, for example, flexible columns 120-1A, 120-2A, 120-3A, 120-4A and 120-5A, on the substrate 110. Each of the flexible columns of the plurality 510 of flexible columns, for example, flexible columns 120-1A, 120-2A, 120-3A, 120-4A and 120-5A, includes an apex of a plurality 520 of apices, for example, apices 120-1C, 120-2C, 120-3C, 120-4C and 120-5C. In accordance with one or more examples of the present invention, the plurality 510 of flexible columns may be produced utilizing a process selected from the group consisting of growing nanowires on the substrate 110, etching the substrate 110, nano-imprinting a coating on the substrate 110, and hot nano-embossing a coating on the substrate 110. For example, in growing nanowires to produce the flexible columns, nanowire seeds are deposited onto the substrate 110, for example, silicon; and, the nanowire is grown during chemical vapor deposition from silane. By way of another example, in etching the substrate to produce the flexible columns, a reactive ion etching (RIE) process is applied to the substrate 110, for example, silicon; and, flexible columns, for example, in the form of nanocones, without limitation thereto, are produced by removing material from the substrate 110 through the action of reactive gaseous molecules, such as, fluorine, chlorine, bromine, or a halogen molecules, in the presence of gaseous nitrogen, argon, or oxygen molecules. By way of yet another example, in nanoimprinting the substrate to produce the flexible columns, a highly viscous thin film, for example, a highly cross-linkable polymer, is applied to the substrate 110, for example, in the form of a web, to produce a coating on the web; and, flexible columns, for example, in the form of nanopoles, without limitation thereto, are produced by rolling the web between a pair of rolls, one of which is a die having a relief pattern that is impressed into the highly viscous thin film coating of the web leaving a negative of the relief pattern of the die in the form of a plurality of nanopoles on the web, substrate 110. The plurality of nanopoles on the substrate 110 may then be cured to cross-link the polymer to obtain a specified compliance in the flexible columns of the nanofingers. By way of yet a further example, in hot nano-embossing a coating on the substrate 110, a polymer, or plastic, is applied to the substrate 110 to produce a coating on the substrate 110; and, flexible columns, for example, in the form of nanopoles, without limitation thereto, are produced by hot embossing the coating with a die, which has a relief pattern that is impressed into the polymer, or plastic, that coats the substrate 110 leaving a negative of the relief pattern of the die in the form of a plurality of nanopoles on the substrate 110. By way of example, in the cases of nano-imprinting a coating on the substrate 110, and hot nano-embossing a coating on the substrate 110, the coating may include magnetizable portions, as previously described, dispersed a material that becomes flexible after curing, for example, a material selected from the group consisting of a highly cross-linkable uv-curable or thermal-curable polymer, a highly cross-linkable uv-curable or thermal-curable plastic, a polysiloxane compound (for example, polyphenylmethyl siloxane (PPMS)), and an epoxy-based negative photoresist (for example, SU-8), without limitation thereto. Thus, flexible columns may be produced with magnetizable portions including magnetizable particles.

With further reference now to FIGS. 5C and 1A-1E, in accordance with one or more examples of the present invention, a cross-sectional elevation view 500C is shown of the nanofinger device 101 with magnetizable portions of FIGS. 1A-1E, nearing a final stage in fabrication. FIG. 5C shows a plurality 120 of nanofingers, for example, nanofingers 120-1, 120-2, 120-3, 120-4 and 120-5, on the substrate 110. Each of the nanofingers, for example, nanofingers 120-1, 120-2, 120-3, 120-4 and 120-5, includes the flexible column of the plurality 510 of flexible columns, for example, flexible columns 120-1A, 120-2A, 120-3A, 120-4A and 120-5A, and the metallic cap of the plurality 530 of metallic caps, for example, metallic caps 120-1B, 120-2B, 120-3B, 120-4B and 120-5B, such that each metallic cap is disposed upon an apex of the plurality 520 of apices, for example, apices 120-1C, 120-2C, 120-3C, 120-4C and 120-5C, respectively. In accordance with one or more examples of the present invention, the plurality 120 of nanofingers may be produced utilizing a process selected from the group consisting of evaporating a metallic cap, for example, metallic cap 120-1B, electroplating a metallic cap, precipitating a metallic cap from a colloidal suspension of metallic nanoparticles, lifting-off portions of a deposited metallic layer to form a metallic cap, and reducing adsorbed metalo-organic compounds by energetic particle bombardment to form a metallic cap. In accordance with one or more examples of the present invention, one or more magnetizable portions of the nanofinger device 101 may include one or more metallic caps, which may be fabricated from metallic materials that may be utilized for such magnetizable portions as previously described.

For example, with further reference to FIGS. 5C and 1A-1E, in accordance with one or more examples of the present invention, in evaporating to produce the metallic caps, a stream of metal vapor 540 is produced, using thin-film vacuum-evaporation techniques, to deposit metal onto the plurality 520 of apices of the plurality 510 of flexible columns 120-1A, 120-2A, 120-3A, 120-4A and 120-5A. The plurality 530 of metallic caps 120-1B, 120-2B, 120-3B, 120-4B and 120-5B are grown from the metal vapor depositing metal onto the plurality 520 of apices 120-1C, 120-2C, 120-3C, 120-4C and 120-5C of the plurality 510 of flexible columns 120-1A, 120-2A, 120-3A, 120-4A and 120-5A. In accordance with one or more examples of the present invention, fabricating the plurality 530 of metallic caps may include evaporating metal at an angle 550 of about 30° to a surface of the substrate 110 onto the plurality 520 of apices 120-1C, 120-2C, 120-3C, 120-4C and 120-5C of the plurality 510 of flexible columns 120-1A, 120-2A, 120-3A, 120-4A and 120-5A. Moreover, in accordance with one or more examples of the present invention, the size, and consequently the spacing, of the metallic caps 120-1B, 120-2B, 120-3B, 120-4B and 120-5B can be controlled by limiting the amount of material deposited from the metallic vapor during the evaporation process. In addition, by way of example, metal vapor 540 may also be deposited at a shallow angle onto the sides of the flexible columns to produce magnetizable portions on the flexible columns including a ferromagnetic metallic coating, without limitation thereto. Other directional deposition techniques, such as ion beam assisted deposition (IBAD) can also be used to deposit the metallic coating materials.

By way of another example, with further reference to FIGS. 5C and 1A-1E, in accordance with one or more examples of the present invention, in electroplating a metallic cap, the substrate 110 including the flexible columns 120-1A, 120-2A, 120-3A, 120-4A and 120-5A is immersed in a plating solution containing metal cations. An electrical potential is applied to the substrate 110 including the flexible columns 120-1A, 120-2A, 120-3A, 120-4A and 120-5A, which results in an enhanced electrical field at the apices, for example, apex 120-1C, of the flexible columns, for example, flexible column 120-1A. The enhanced electrical field attracts the metal cations to the apices, for example, apex 120-1C, of the flexible columns, for example, flexible column 120-1A, where chemical reduction of the metal cations occurs and metal is deposited to grow the metallic caps, for example, metallic cap 120-1B.

Similarly, by way of another example, with further reference to FIGS. 5C and 1A-1E, in accordance with one or more examples of the present invention, in precipitating metallic caps from a colloidal suspension of metallic nanoparticles, the substrate 110 including the flexible columns 120-1A, 120-2A, 120-3A, 120-4A and 120-5A is immersed in a colloidal suspension of metallic nanoparticles. An electrical potential is applied to the substrate 110 including the flexible columns 120-1A, 120-2A, 120-3A, 120-4A and 120-5A, which results in an enhanced electrical field at the apices, for example, apex 120-1C, of the flexible columns, for example, flexible column 120-1A. The enhanced electrical field attracts metallic nanoparticles from the colloidal suspension to the apices, for example, apex 120-1C, of the flexible columns, for example, flexible column 120-1A, where the metallic nanoparticles are deposited to grow the metallic caps, for example, metallic cap 120-1B.

By way of yet another example, with further reference to FIGS. 5C and 1A-1E, in accordance with one or more examples of the present invention, in a lift-off process for lifting-off portions of a deposited metallic layer to produce the metallic caps, a layer of photoresist is applied to the substrate 110 including the flexible columns 120-1A, 120-2A, 120-3A, 120-4A and 120-5A. An undercut structure is produced in the photoresist adjacent to the sides of the flexible columns, and the photoresist is etched away from the apices 120-1C, 120-2C, 120-3C, 120-4C and 120-5C of the flexible columns 120-1A, 120-2A, 120-3A, 120-4A and 120-5A. The stream of metal vapor 540 is deposited, using thin-film deposition techniques, for example, sputtering or evaporation, onto the plurality 520 of apices of the plurality 510 of flexible columns 120-1A, 120-2A, 120-3A, 120-4A and 120-5A. A thin film is deposited over the surface of the combined photoresist and partially fabricated nanofinger device 101. The photoresist and portions of the metal layer adhering to the photoresist between the flexible columns 120-1A, 120-2A, 120-3A, 120-4A and 120-5A is then removed and the plurality 530 of metallic caps 120-1B, 120-2B, 120-3B, 120-4B and 120-5B is left adhering to the plurality 520 of apices 120-1C, 120-2C, 120-3C, 120-4C and 120-5C of the plurality 510 of flexible columns 120-1A, 120-2A, 120-3A, 120-4A and 120-5A.

By way of yet a further example, with further reference to FIGS. 5C and 1A-1E, in accordance with one or more examples of the present invention, in reducing adsorbed metalo-organic compounds by energetic particle bombardment to produce the metallic caps 120-1B, 120-2B, 120-3B, 120-4B and 120-5B, the substrate 110 including the flexible columns 120-1A, 120-2A, 120-3A, 120-4A and 120-5A is exposed to a vapor of a chemical compound bearing a metal moiety, for example, a metalo-organic compound as used in chemical vapor deposition (CVD). For example, the metalo-organic compound may be provided in the form of a gas admitted to a vacuum chamber, such as, the vacuum chamber of a focused-ion beam (FIB) tool, a scanning electron microscope (SEM), or the target chamber of a laser ablation system, without limitation thereto. A suitable gas-injection system (GIS) interfaced to the vacuum chamber may be used to provide the chemical vapor bearing a metal moiety, for example, the metalo-organic compound. The gaseous vapor of the metalo-organic compound adsorbs on the surface of the substrate 110 including the apices 120-1C, 120-2C, 120-3C, 120-4C and 120-5C of the flexible columns 120-1A, 120-2A, 120-3A, 120-4A and 120-5A. An energetic beam of particles, for example, ions, electrons, or photons, without limitation thereto, irradiates the apices 120-1C, 120-2C, 120-3C, 120-4C and 120-5C of the flexible columns 120-1A, 120-2A, 120-3A, 120-4A and 120-5A. Such energetic beams of particles, for example, ions, electrons, or photons, without limitation thereto, may be provided, for example, by: the ion gun of a FIB tool, the electron gun of an SEM, or a laser of a laser ablation system, without limitation thereto. The energetic beam of particles, for example, ions, electrons, or photons, without limitation thereto, reduces the adsorbed gaseous vapor of the metalo-organic compound and grows the plurality 530 of metallic caps 120-1B, 120-2B, 120-3B, 120-4B and 120-5B onto the plurality 520 of apices 120-1C, 120-2C, 120-3C, 120-4C and 120-5C of the plurality 510 of flexible columns 120-1A, 120-2A, 120-3A, 120-4A and 120-5A.

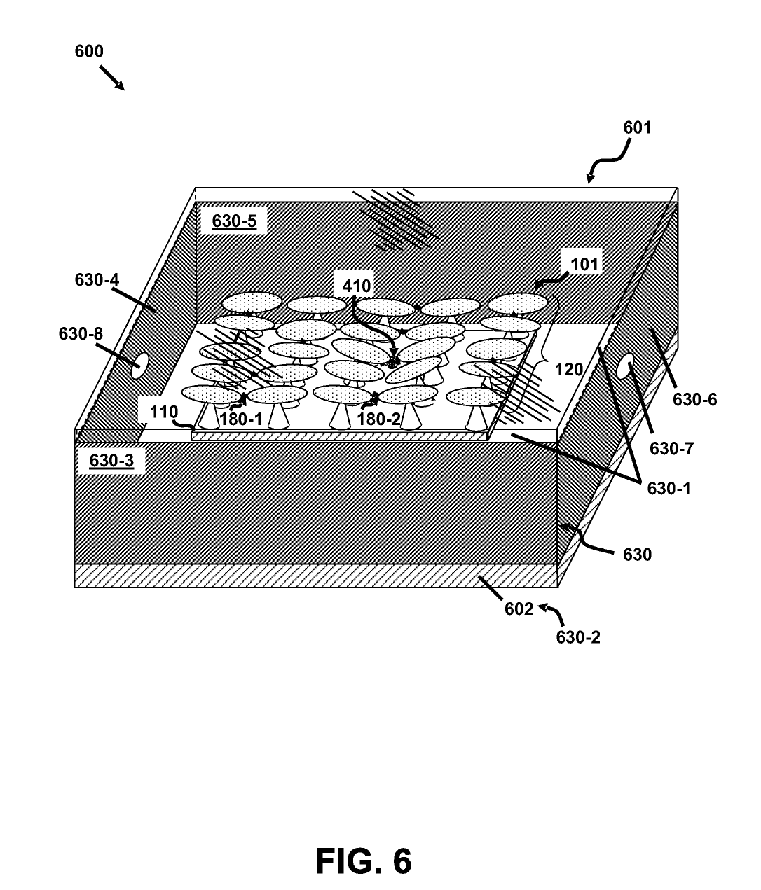

With reference now to FIG. 6 and further reference to FIGS. 1A-5C, in accordance with one or more examples of the present invention, a perspective view 600 is shown of the nanofinger device 101 with magnetizable portion, as utilized for chemical sensing, which includes a microfluidic channel 601. The nanofinger device 101 may further include the microfluidic channel 601 to transport a fluid 212 to and from the plurality 120 of nanofingers disposed within a portion of the microfluidic channel 601. The nanofinger device 101 includes the examples previously described above, as these examples may be incorporated within the environment of microfluidic channel 601 being within the spirit and scope of examples of the present invention. A change in optical response from the nanofinger device 101 may be produced upon exposing the nanofinger device 101 including the microfluidic channel 601 to the fluid 212, and purging the microfluidic channel 601 of the fluid 212. The microfluidic channel 601 may further include an enclosure 630 to encapsulate the plurality 120 of nanofingers of the nanofinger device 101 and to confine the analyte molecule 180-1 within the enclosure 630 of the nanofinger device 101.

With further reference to FIG. 6 and FIGS. 1A-5C, in accordance with one or more examples of the present invention, the enclosure 630 of the microfluidic channel 601 may include: an enclosure cover 630-1; an enclosure base 630-2, which may include a platform 602; enclosure sidewalls 630-3, 630-4, 630-5, 630-6 attached to the enclosure cover 630-1 and attached to the enclosure base 630-2; an enclosure inlet 630-7 to admit the fluid 212 into the enclosure; and, an enclosure outlet 630-8 to remove the fluid 212 from the enclosure 630. By way of example, the enclosure 630 has been shown in FIG. 6 as a box-like structure such that the enclosure base 630-2 includes the platform 602. However, in another example of the present invention, the enclosure base 630-2 may be separate from the platform 602. For example, within the spirit and scope of examples of the present invention, the nanofinger device 101 including the microfluidic channel 601 may include an enclosure having a cylindrical, or other alternative shape. Moreover, within the spirit and scope of examples of the present invention, although the enclosure cover 630-1, the enclosure base 630-2 and the enclosure sidewalls 630-3, 630-4, 630-5, 630-6 are shown as essentially planar structures, the enclosure cover 630-1, the enclosure base 630-2 and the enclosure sidewalls 630-3, 630-4, 630-5, 630-6 may have shapes other than shown in FIG. 6, without limitation thereto. Similarly, although, by way of example, the enclosure inlet 630-7 and the enclosure outlet 630-8 are shown in FIG. 6 as orifices in the respective enclosure sidewalls 630-4 and 630-6, the enclosure inlet 630-7 and the enclosure outlet 630-8 may include other structures such as tubes, channels or ducts, which are within the spirit and scope of examples of the present invention. Moreover, within the spirit and scope of examples of the present invention, a shape and geometrical configuration of the enclosure 630, other than depicted in FIG. 6 by way of example, may be provided by microfabrication techniques. In accordance with other examples of the present invention, any of the enclosure cover 630-1, the enclosure base 630-2, the enclosure sidewalls 630-3, 630-4, 630-5, 630-6, the platform 602, and the substrate may be transparent to exciting electromagnetic radiation 715 (see FIG. 7) that may be used to excite the analyte molecule 180-1, and may be transparent to emitted electromagnetic radiation 725 (see FIG. 7) that may be emitted from the analyte molecule 180-1 in response to the exciting electromagnetic radiation 715.

With further reference to FIG. 6 and FIGS. 1A-5C, in accordance with one or more examples of the present invention, the nanofinger device 101 including the microfluidic channel 601 allows for a fluid 212, for example, a liquid sample, which can be introduced into the nanofinger device 101 in small volumes. For example, in one or more examples of the present invention, the following operations may be preformed: a liquid may be introduced from the enclosure inlet 630-8; sufficient interaction time may then be provided for interaction of the liquid with the nanofinger device 101; a gas, for example, air, may be blown through the enclosure 630 to purge the nanofinger device 101 of the liquid and to dry the metallic-nanofingers of the nanofinger device 101; and, sufficient time may then be provided for the metallic-nanofingers to close under microcapillary forces that are induced by the evaporation of the liquid.

With reference now to FIG. 7, in accordance with one or more examples of the present invention, a perspective view 700 is shown of a chemical-analysis apparatus 701 including the nanofinger device 101 with magnetizable portions, as utilized for chemical sensing. The chemical-analysis apparatus 701 includes a nanofinger device 101 with magnetizable portion, as utilized for chemical sensing, a source 710 of exciting electromagnetic radiation 715 to excite the analyte molecule 180-1 captured by the nanofinger device 101, and a detector 720 to detect emitted electromagnetic radiation 725 that may be emitted from the analyte molecule 180-1 in response to the exciting electromagnetic radiation 715. Examples of the present for the nanofinger device 101, as described above, may be incorporated within the environment of the chemical-analysis apparatus 701. The chemical-analysis apparatus 701 may also include a dispersion unit (not shown), such as a diffraction grating and slit interposed between the nanofinger device 101 and the detector 720. For such a spectroscopic configuration including a dispersion unit, the chemical-analysis apparatus 701 may selectively disperse the emitted electromagnetic radiation 725 as a function of wavelength. Alternatively, in other examples of the present invention, the chemical-analysis apparatus 701 might not be configured as a spectrometer with a dispersion unit, but as, for example, a reflectometer, without limitation thereto.

With further reference to FIG. 7 and further reference to FIGS. 1A-6, in accordance with other examples of the present invention, an example configuration is shown for SERS, without limitation thereto, of analyte molecules disposed between the metallic caps of the nanofinger device 101 for chemical sensing. In accordance with one or more examples of the present invention, the chemical-analysis apparatus 701 may include the nanofinger device 101 configured as component parts selected from the group consisting of a mirror, a grating, a wave-guide, a microfluidic channel, a cuvette and an analytical cell any of which may be disposed in the chemical-analysis apparatus 701. In accordance with one or more examples of the present invention, the chemical-analysis apparatus 701 may include a spectrometer, for example, a Raman spectrometer, without limitation thereto. Thus, in accordance with one or more examples of the present invention, the chemical-analysis apparatus 701 may include, more generally, an instrument selected from the group consisting of a reflectometer, a spectrometer, a spectrophotometer, a Raman spectrometer, and an instrument to accept the nanofinger device 101 for optical analysis and/or spectroscopic analysis.

In another example, with further reference to FIGS. 1A-7, in accordance examples of the present invention, one configuration of the chemical-analysis apparatus 701 includes a spectrometer to accept the nanofinger device 101 for performing spectroscopy, for example, SERS, of at least one molecule, for example, analyte molecule 180-1, analyte molecule 180-2, and/or analyte molecule 410. The spectrometer includes a source 710 of exciting electromagnetic radiation 715 that is used to excite at least one molecule, for example, analyte molecule 410. The source 710 of exciting electromagnetic radiation 715 may be a laser, without limitation thereto. The energy of a photon of the exciting electromagnetic radiation 715 is given by Planck's constant times the frequency of the laser source, given by: hνₗₐₛₑᵣ. In addition, the spectrometer includes a dispersion unit (not shown) and a detector 720 that are used to analyze and detect emitted electromagnetic radiation 725. The emitted electromagnetic radiation 725 emerges from the analyte molecule 410 in response to the source 710 that includes an exciting laser. For example, in the case of SERS, the energy of a photon of the emitted electromagnetic radiation 725 from the analyte molecule 410 is given by Planck's constant, h, times the frequency of the molecular source, ν_{SERS}, given by: hν_{SERS}=hνₒ+hΔ, where νₒ is the frequency of the incident laser field and Δ the Raman shift. Because of the interaction with surface plasmons excited in the plurality of metallic caps, for example, metallic caps 120-1B and 120-2B, metallic caps 120-3B and 120-4B, and metallic caps 120-8B, 120-9B, 120-13B and 120-14B, of the plurality of nanofingers, the magnitude of the local electric field E_{molecule}, at a molecule for example, analyte molecule 180-1, analyte molecule 180-2, or analyte molecule 410, respectively, is enhanced compared to the incident field Eₒ.

With further reference to FIGS. 1A-7, in accordance with one or more examples of the present invention, the composition of the metallic cap is such that the surface plasmons excited in the metallic cap are within the wavelength ranges of the exciting electromagnetic radiation 715 and the electromagnetic radiation emitted from the analyte molecule 410. These wavelength ranges may extend from the near ultraviolet to the near infrared. Thus, in accordance with one or more examples of the present invention, the plurality of metallic caps may be composed of a noble metal constituent. Alternatively, the plurality of metallic caps may be composed of a constituent selected from the group of constituents consisting of copper, silver and gold. In one example of the present invention, the metallic caps may be composed of a magnetizable portion of the nanofinger coated with a noble metal, such as copper, silver and/or gold. In accordance with an example of the present invention, the signal associated with the emitted electromagnetic radiation 725 is amplified by increasing the number of metallic caps in proximity to which a molecule is disposed. Examples of the present invention increase the number of metallic caps, for example, metallic caps 120-8B, 120-9B, 120-13B and 120-14B, in proximity to a molecule, for example, analyte molecule 410, by employing the plurality 120 of nanofingers including the plurality 510 (see FIG. 5B) of flexible columns upon which the plurality 530 (see FIG. 5C) of metallic caps are disposed. Thus, in accordance with one or more examples of the present invention, due to the increased number of metallic caps, an increase in the excitation of surface plasmons in proximity to the analyte molecule 410 is expected to enhance the signal from the analyte molecule 410 in SERS. Therefore, examples of the present invention provide a nanofinger device 101 that provides for surface-enhanced luminescence, for example, for SERS, without limitation thereto.

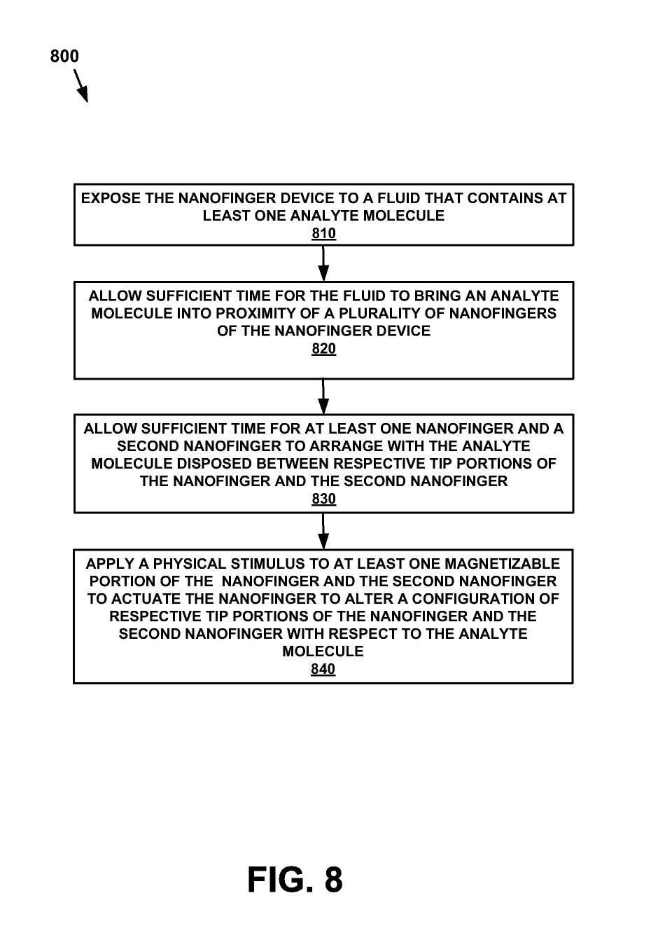

With reference now to FIG. 8, in accordance with one or more examples of the present invention, a flowchart 800 is shown of a method of using a nanofinger device for chemical sensing with magnetizable portion. The method of using a nanofinger device for chemical sensing with magnetizable portion includes the following operations. At 810 the nanofinger device is exposed to a fluid that contains at least one analyte molecule. At 820 sufficient time is allowed for the fluid to bring the analyte molecule into proximity of a plurality of nanofingers of the nanofinger device. At 830 sufficient time is allowed for at least one nanofinger and a second nanofinger to arrange with the analyte molecule disposed between respective tip portions of the nanofinger and the second nanofinger. After 830, the method may further include, without limitation thereto, purging the nanofinger device of the fluid, and if the fluid is a liquid, allowing microcapillary forces to close the nanofinger and the second nanofinger to self-arrange into a close-packed configuration with the analyte molecule disposed between respective tip portions of the nanofinger and the second nanofinger. At 840 a physical stimulus is applied to at least one magnetizable portion of the nanofinger and the second nanofinger to actuate the nanofinger to alter a configuration of the respective tip portions of the nanofinger and the second nanofinger with respect to the analyte molecule. Operation 840 may include: either closing the nanofinger and the second nanofinger to arrange into a close-packed configuration with the analyte molecule disposed between respective tip portions of the nanofinger and the second nanofinger, as an alternative, or in addition, to allowing microcapillary forces to close the nanofinger and the second nanofinger into a close-packed configuration; and/or, opening the nanofinger from a close-packed configuration to allow release of the analyte molecule, as previously described. During capture of the analyte molecule by the nanofingers in the close-packed configuration, the method further allows for chemical sensing of the analyte molecule by exciting the analyte molecule captured by the nanofinger device with exciting electromagnetic radiation, and detecting emitted electromagnetic radiation that may be emitted from the analyte molecule in response to the exciting electromagnetic radiation. As previously described, this allows for analysis of the analyte molecule by surface-enhanced luminescence, for example, by SERS, without limitation thereto. Moreover, since the magnetizable portions of the nanofingers may be repeatedly actuated for cyclic, or repeated, chemical sensing, the method may further include: exposing the nanofinger device to a purging fluid; allowing sufficient time for the purging fluid to remove the analyte molecule from proximity to the plurality of nanofingers of the nanofinger device; and, purging the nanofinger device of the purging fluid containing the analyte molecule. Thus, in accordance with one or more examples of the present invention, the nanofinger device may be re-initialized to capture another analyte molecule for cyclic, or repeated, chemical sensing of analyte molecules.

Examples of the present invention include a nanofinger device 101 with magnetizable portions, which in some examples of the present invention may be utilized for chemical sensing. A nanofinger device, utilized for chemical sensing, can provide enhanced sensitivity for the presence of analyte molecules through surface-enhanced luminescence. In addition, a nanofinger device may provide for lower detectability limits in surface-enhanced luminescence of an analyte associated with an analyte molecule in solution. The nanofinger device may also be implemented without a spectrometer, or a laser light source. On the other hand, if a Raman spectrometer is used, the nanofinger device may also provide for lower detectability limits in SERS analysis of a molecule. Beyond such applications of a nanofinger device, the nanofinger device 101 with magnetizable portions also allows for repeated chemical analysis, without having to dispose of the nanofinger device, after the nanofinger device has captured an analyte molecule. Thus, new applications of a nanofinger device may be realized with a nanofinger device 101 having magnetizable portions in which the nanofinger device 101 with magnetizable portions may be reused, and/or cyclically operated, which can substantially lower the cost of performing analyses with a nanofinger device. Thus, the inventors expect new applications of examples of the present invention in at least medical, environmental, chemical, and biological technologies, without limitation thereto.

The foregoing descriptions of specific examples of the present invention have been presented for purposes of illustration and description. They are not intended to be exhaustive or to limit the invention to the precise forms disclosed, and many modifications and variations are possible in light of the above teaching. The examples described herein were chosen and described in order to best explain the principles of the invention and its practical application, to thereby enable others skilled in the art to best utilize the invention and various examples with various modifications as are suited to the particular use contemplated. It may be intended that the scope of the invention be defined by the claims appended hereto and their equivalents.

1. A nanofinger device with magnetizable portion, said device comprising:
a substrate; and
a plurality of nanofingers coupled with said substrate, a nanofinger of said plurality comprising:
a flexible column;
at least one magnetizable portion; and
a metallic cap coupled to an apex of said flexible column, said metallic cap composed all, or in part, of a SERS-active metal;
wherein at least said nanofinger and a second nanofinger of said plurality of nanofingers are to arrange into a close-packed configuration; and
wherein said magnetizable portion is to actuate said nanofinger in opening from said close-packed configuration in response to a physical stimulus affecting a magnetic state of said magnetizable portion.

2. The nanofinger device of claim 1, wherein said nanofinger and said second nanofinger of said plurality of nanofingers upon arranging into said close-packed configuration and upon illumination with exciting electromagnetic radiation produce an enhanced optical response greater than an optical response in an absence of arranging into said close-packed configuration.

3. The nanofinger device of claim 2, further comprising:
a chemical sensor for at least one analyte molecule; and
wherein said nanofinger and said second nanofinger of said plurality of nanofingers are to arrange into said close-packed configuration with said analyte molecule disposed in between respective tip portions of said nanofinger and said second nanofinger, and to produce an enhanced optical response associated with said analyte molecule greater than an optical response in an absence of arranging into said close-packed configuration with said analyte molecule.

4. The nanofinger device of claim 3, wherein said enhanced optical response associated with said analyte molecule comprises surface-enhanced Raman luminescence.

5. The nanofinger device of claim 1, wherein said physical stimulus is selected from the group consisting of a change in temperature and a change in applied magnetic field.

6. The nanofinger device of claim 1, wherein said magnetizable portion comprises a structure selected from the group consisting of a superparamagnetic particle, a paramagnetic particle, a magnetic particle, a ferromagnetic coating of said flexible column, a ferromagnetic flexible column, a ferromagnetic cap disposed at an apex of said flexible column, a thermomagnetic coating of said flexible column, a thermomagnetic flexible column, and a thermomagnetic cap disposed at an apex of said flexible column, and any combination of foregoing members of said group.

7. The nanofinger device of claim 1, wherein said flexible column comprises a composite structure formed from a dispersion of a plurality of magnetizable particles in a non-magnetic matrix; and
wherein said magnetizable particles are selected from the group consisting of a superparamagnetic particle, a paramagnetic particle, a magnetic particle, and any combination of foregoing members of said group.

8. The nanofinger device of claim 1, wherein said magnetizable portion is to actuate said nanofingers in closing into said close-packed configuration in response to a physical stimulus affecting a magnetic state of said magnetizable portion.

9. The nanofinger device of claim 8, wherein said plurality of nanofingers are to open from said close-packed configuration and to close into said close-packed configuration, repeatedly, in response to changes in physical stimuli.

10. The nanofinger device of claim 1, further comprising:
a microfluidic channel to transport a fluid to and from said plurality of nanofingers disposed within a portion of said microfluidic channel.

11. The nanofinger device of claim 1, further comprising:
at least one magnet to apply an applied magnetic field to magnetizable portions of nanofingers of said plurality of nanofingers to alter a configuration of said plurality of nanofingers.

12. The nanofinger device of claim 1, further comprising:
a thermal reservoir to change a temperature of at least one magnetizable portion of nanofingers of said plurality of nanofingers to alter a configuration of said plurality of nanofingers.

13. A chemical-analysis apparatus, comprising:
a nanofinger device for chemical sensing with magnetizable portion, said device comprising:
a substrate; and
a plurality of nanofingers coupled with said substrate, a nanofinger of said plurality comprising:
a flexible column;
at least one magnetizable portion; and
a metallic cap coupled to an apex of said flexible column, said metallic cap composed all, or in part, of a SERS-active metal;
wherein at least said nanofinger and a second nanofinger of said plurality of nanofingers are to arrange into a close-packed configuration; and
wherein said magnetizable portion is to actuate said nanofinger in opening from said close-packed configuration in response to a physical stimulus affecting a magnetic state of said magnetizable portion; and
a source of exciting electromagnetic radiation to excite an analyte molecule captured by said nanofinger device; and
a detector to detect emitted electromagnetic radiation that may be emitted from said analyte molecule in response to said exciting electromagnetic radiation.

14. The chemical-analysis apparatus of claim 13, further comprising:
an instrument selected from the group consisting of a reflectometer, a spectrometer, a spectrophotometer, a Raman spectrometer, and an instrument to accept said nanofinger device for optical analysis.

15. A method of using a nanofinger device for chemical sensing with magnetizable portion, said method comprising the following operations:
exposing said nanofinger device to a fluid containing at least one analyte molecule;
allowing sufficient time for said fluid to bring an analyte molecule into proximity of a plurality of nanofingers of said nanofinger device;
allowing sufficient time for at least one nanofinger and a second nanofinger to arrange with said analyte molecule disposed between respective tip portions of said nanofinger and said second nanofinger;
applying a physical stimulus to at least one magnetizable portion of said nanofinger and said second nanofinger to actuate said nanofinger to alter a configuration of said respective tip portions of said nanofinger and said second nanofinger with respect to said analyte molecule.

16. The method of claim 15, further comprising:
purging said nanofinger device of said fluid; and
if said fluid is a liquid, allowing microcapillary forces to close said nanofinger and said second nanofinger to self-arrange into a close-packed configuration with said analyte molecule disposed between respective tip portions of said nanofinger and said second nanofinger.

17. The method of claim 15, wherein applying said physical stimulus to at least one magnetizable portion of said nanofinger and said second nanofinger to actuate said nanofinger to alter a configuration of said respective tip portions of said nanofinger and said second nanofinger with respect to said analyte molecule further comprises:
closing said nanofinger and said second nanofinger to arrange into a close-packed configuration with said analyte molecule disposed between respective tip portions of said nanofinger and said second nanofinger.

18. The method of claim 15, further comprising:
exciting said analyte molecule captured by said nanofinger device with exciting electromagnetic radiation; and
detecting emitted electromagnetic radiation that may be emitted from said analyte molecule in response to said exciting electromagnetic radiation.

19. The method of claim 15, wherein applying said physical stimulus to at least one magnetizable portion of said nanofinger and said second nanofinger to actuate said nanofinger to alter a configuration of said respective tip portions of said nanofinger and said second nanofinger with respect to said analyte molecule further comprises:
opening said nanofinger from a close-packed configuration to allow release of said analyte molecule.

20. The method of claim 15, further comprising:
exposing said nanofinger device to a purging fluid;
allowing sufficient time for said purging fluid to remove said analyte molecule from proximity to said plurality of nanofingers of said nanofinger device; and
purging said nanofinger device of said purging fluid containing said analyte molecule;
wherein said nanofinger device is re-initialized to capture another analyte molecule.
